(19) United States
(12) Patent Application Publication
(10) Pub. No.: US 2007/0168081 A1
(43) Pub. Date: Jul. 19, 2007

(54) Analytic integration of tolerances in designing precision interfaces for modular robotics

(76) Inventors: Sung-Ho Shin, Austin, TX (US); Delbert Tesar, Austin, TX (US)

Correspondence Address: HULSEY IP INTELLECTUAL PROPERTY LAWYERS, P.C., 1250 S. CAPITAL OF TEXAS HIGHWAY, BUILDING THREE, SUITE 610, AUSTIN, TX, 78746, US

(21) Appl. No.: 11/430,261

(22) Filed: Nov. 20, 2006

Related U.S. Application Data
(60) Provisional application No. 60/678,864, filed on May 6, 2005.

(51) Int. Cl. G06F 19/00

(52) U.S. Cl. 700/245

(57) ABSTRACT

A robotic system providing precision interfaces between a rotary actuator and a robotic structure. The robotic structure responsive to control by a rotary actuator via a connection means whereby interface design parameters are relayed to the rotary actuator. The rotary actuator for controlling the robotic structure includes an actuator shell, an eccentric cage and a primer mover portion, rigidly attached to the eccentric cage and capable of exerting a torque on a first prime mover. A cross-roller is also included having a first bearing portion rigidly fixed to the actuator shell and a second bearing portion, an output attachment plate attached to a second bearing portion, a shell gear rigidly attached to the actuator shell, an output gear attached to the output attachment plate and an eccentric gear attached to the eccentric cage.

### I. BACKGROUND OF THE INVENTION

The concept of modular robotics emerged in the 1980's for improved cost effectiveness in manufacturing use of robots. Modular robotics is now gaining more attention due to the potential power of reconfigurability it brings to the structure of robots. The conventional monolithic robots were not only expensive to own and maintain, but they were also very limited in flexibility in the sense that their fixed structure prevented them from being successfully applied to different tasks on demand. For the same reason, they often failed to constantly update with new component technologies available and therefore became obsolete.

Modularity in robot design allows for reconfigurability, which can serve as a solution to those problems associated with the monolithic robot structure. It enables generating many different configurations suitable for tasks of different purposes using a set of interconnecting modules. A module can be easily removed and replaced with another in such cases where a fault is found in it, a different functionality is required, or it needs to be upgraded for new technologies. Such granular nature of the modular structure and recent advances in component technology are gradually shifting the research emphasis from the functionality of the entire system towards the performance and design of individual modules.

The concept of modular robotics can only be successfully realized through the development of self-contained independent modules. The other key to the success of modular robotics is the ability to replace modules efficiently while maintaining the accuracy and stiffness of the system. This ability can be achieved through the development of accurate, repeatable, stiff, light, and convenient module connection interfaces. These requirements necessitate standardized component technology for modules and their connection interfaces. Standardization can bring the cost of robots further down and, at the same time, precipitate development of the component technology.

Because of the way modular robots are built by connecting different modules using their interfaces (See FIG. 1), the end-effecter error of a modular robot is the sum of the error contributions from the individual modules as well as their interface connections. The errors associated with an individual module include the compliance error due to structural deflections and the geometry error due to manufacturing imperfections. Both of these errors can be compensated through the measurements of the ‘as-built’ parameters of the manufactured modules. However, the assembly error that is determined at the time of each module connection introduces yet another uncertainty into the geometry of the total system.

FIG. 1 depicts a powercube modular robot.

Normally, these assembly errors at the module connections need to be compensated through the calibration of the entire robot after every module replacement performed. Here, module replacement can be either a complete reconfiguration of the entire structure or simply changing out certain modules in the existing configuration. This requirement for frequent calibrations can greatly diminish the benefits that the reconfigurability brings about and thus can be a potential obstacle for the development of modular robotics in the long run. If, however, the selected interface design can guarantee the level of connection accuracy, then we'll be able to correctly predict the accuracy of the reconfigured system just by using the ‘as-built’ geometry data of the modules provided by their manufacturer. Further, the system can be put to work without performing any additional calibrations, if the predicted accuracy suffices the needed level of precision. Both the connection assembly error and the connection compliance need to be minimized and correctly predicted through proper designing of the interfaces.

Despite current efforts being placed in module development, the importance of the connection interfaces in modular robotics has been largely neglected thus far. This leaves the development of high performance interfaces yet to be resolved, featuring high connection accuracy, high stiffness, low weight, low cost and convenience. Among those requirements, the connection accuracy is of the paramount importance at this stage, since the highest level of reconfigurability can only be accomplished when the accuracy level of continuously reconfigured systems can be either preserved or at least predicted.

FIG. 2. depicts schematic definitions of accuracy and repeatability

The relative position and orientation of the connecting bodies depend on the physical interactions that take place at all of the local contact points and the structural deformation of the interfaces during the connection process. They are functions of the detail geometry of the interfaces and properties of the material used. Designing a modular interface for a good connection accuracy, therefore, requires properly management of the overall interface geometry, local contact geometries and their configurations, which are to be specified in the form of dimension values associated with them.

The dimension values of designed parts are specified together with the corresponding tolerance limits suitable for the selected manufacturing processes. Tolerance (* Tolerance in this research is limited to dimension tolerances excluding geometric feature tolerances) is one of the major factors that determine both the performance of manufactured products and their cost. Tolerance allocation becomes particularly important if it is for a precision part such as a modular interface, whose tolerances can directly affect the accuracy of the assembled system. To this end, tolerances must be considered to some extent from the initial design stage, together with other design variables of the interface. In order to do so efficiently, a simple method is needed to measure the influence of the selected tolerances and other design variables on the final relative position and orientation of the connection, even if the calculation is approximate.

Guerrero and Tesar [15] of UT-Austin's Robotics Research Group (RRG) has previously suggested the contact spring method as the first approximation tool for predicting the connection accuracy between two modular interfaces with dimension variations. In their formulation, the force-deflection relation at a local contact area was modeled as distributed mechanical springs, whose stiffness can be obtained from contact theories [57]. They demonstrated the potential of the contact spring method as a simple approximation technique, through a simple, single degree-of-freedom (DOF) model.

Different interface or coupling designs from previous works show their emphasis on different aspects of connection problems such as ease of assembly, accuracy and stiffness. Guerrero and Tesar also presented a set of conceptual interface designs for modular robotics and performed detailed designing and accuracy analysis on one of the concepts named “HSCC”. The major design effort was to gain a better control over the connection accuracy by minimizing the combined influences of variations of different dimensions over the position variations in each direction of DOF.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts a powercube modulator robot;

FIG. 2 depicts schematic definitions of accuracy and repeatability;

FIG. 3 depicts a connection design with loose tolerances;

FIGS. 4A and 4B depict 2- and 3-D conceptualization of a connection interface;

FIG. 5 depicts an ALPHA manipulation shoulder module connection interface components;

FIG. 6 depicts an ALPHA arm module configuration;

FIG. 7 depicts a standardized rotary actuator;

FIGS. 8A and 8B depict a simplified diagrams of transverse clamping forces.;

FIG. 9 depicts a free-body-diagram of a band spring segment on a C-clamp of arbitrary angle of revolution;

FIG. 10 depicts a free body diagram of a band spring segment;

FIG. 11 depicts force equilibrium in wedging with friction;

FIG. 12 depicts a symmetric half of a C-clamp of angle of revolution;

FIG. 13 depicts a circular arc teeth contact configuration;

FIGS. 14A-14C depicts gear teeth with added tip compliance;

FIG. 15 depicts a fully stressed beam profile;

FIG. 16 depicts a deflection and slope of a fully stressed beam;

FIG. 17 depicts a fundamental local contact geometry;

FIGS. 18A-18C depict stress distribution of modified local contact couple;

FIGS. 19A and 19B depict FEM contact simulation module;

FIGS. 20A-20C depict contact teeth arrangement and numbering;

FIG. 21 depicts a lower body tooth vector chain;

FIG. 22 depicts upper body geometry parameters;

FIGS. 23A and 23B depicts FEM and CSM results comparison plots (x);

FIGS. 24A and 24B depicts FEM and CSM results comparison plots (y);

FIGS. 25A and 25B depicts FEM and CSM results comparison plots (θ);

FIG. 26 depicts a final local contact geometry;

FIG. 27 depicts low precision radial accuracy plots;

FIG. 28 depicts low precision angular accuracy plots;

FIG. 29 depicts high precision radial accuracy plots;

FIG. 30 depicts high precision angular accuracy plots;

FIGS. 31A and 31B depict designed connection interface parts;

FIG. 32 depicts designed interface parts in connection;

FIG. 33 depicts internal force path of a standard actuator module;

FIG. 34 depicts and interface structure FEM model;

FIGS. 35A-35C depict interfaces utilizing local compliance for increased connection stiffness;

FIG. 36 depicts a connection system model with tolerances;

FIG. 37 depicts a 2-Dimensional interface local contact model;

FIG. 38 depicts three states of the solution process;

FIGS. 39A and 39B depict a lower body and upper body coordinate system distribution example;

FIG. 40 depicts a designed local geometry; and

FIGS. 41A and 41B depict an interface concept utilizing contact compliance.

### A OBJECTIVES

In the first part of this research, a simple and approximate formulation to be used in the initial phase of module connection interface design is pursued, by relating the major design parameters such as contact stiffness, geometry dimensions and dimensional tolerances to the final relative position and orientation of connected interfaces. This is initiated by finding the force equilibrium equations and position compatibility equations of the connected state using a simplified kinematic model of the interface connection. Specifically, the concept of contact spring from the former research is adopted to obtain approximate single-step solutions for over-constrained multi-DOF problems. The primary purpose of this method is to efficiently obtain an initial set of design parameter values, including tolerances, out of many possible variable sets that a designer can face with.

In the subsequent part of the research, the contact spring formulation is applied to design a precision module connection interface for a particular system, following an assessment on the desirable level of connection accuracy and stiffness. The overall interface geometry and configuration are based on the former design. Ring geometry is used to maximize space efficiency, which is the primary condition for modular architecture. Manufacturing simplicity is emphasized to minimize both error sources and number of design parameters. Nominal dimensions and dimensional tolerances are allocated through comparative analyses utilizing the multi-DOF contact spring formulation developed in the first part of the research. Finite element method (FEM) contact simulation is used to verify the error calculations from the contact spring method.

### B. Research Scope

Since a connection between two bodies is made through the establishment of local contacts, designing a modular interface for good connection accuracy requires proper management of the local contact geometries and their overall configuration. Two different approaches can be undertaken in designing of mechanical interfaces. One is based on complete rigid body kinematics with exact constraining. The number of constraints provided by one rigid body to position and hold another body must be the same as the number of DOF's in the space in order to avoid redundancy. The other design approach employs elastic averaging principle for over-constrained systems. More restraints than the number of DOF's are allowed, but the elastic behavior needs to be properly designed in order to achieve a desired solution.

The weakness of the first approach is that it produces unrealistic designs, mainly due to the assumption of perfectly rigid bodies and also because of the limitation of exactly six contact points. No real world bodies can be perfectly rigid and the compliances at the non-conforming contacts between interfaces will definitely affect connection accuracy as well as connection stiffness, especially when there are only six of such contacts. Locating those contact points at certain desirable locations and orienting them in the right directions can not only limit the choices in overall geometry and configuration, but also can significantly increase cost and the level complexity in manufacturing.

When a single DOF is constrained more than once, the system is then over-constrained and a position solution either exists with redundancy or doesn't exist at all. Having more constraints can be helpful for strength or stability, for example, but then achieving a single point solution with redundant constraints would be as much difficult as to manufacture with zero tolerances. In general, manufactured parts do not have perfect geometry and bringing the manufacturing errors to near zero obviously is extremely costly. It is this reason why over-constrained designs of relatively rigid structures often fail to be assembled or to function properly, like a poorly finished four-legged chair doesn't find a single position on the floor.

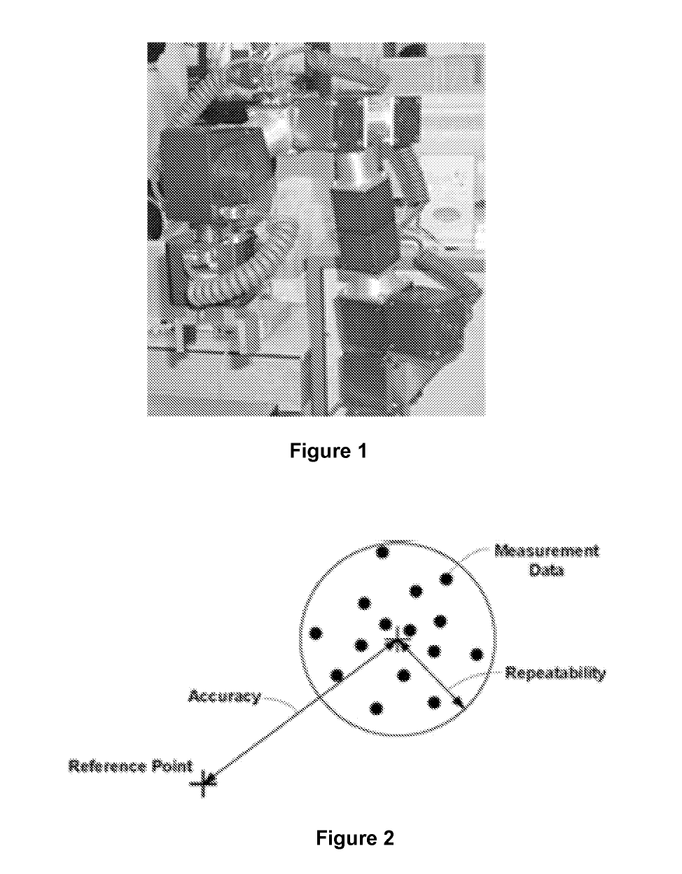

To avoid this kind of solution/no-solution or ‘go/no-go’ situation and excessive manufacturing costs in mechanical systems, two methods can be used other than simply tightening tolerance specifications. To stay within the rigid body design regime, restraints can be rather loosened so that some of the DOF's are restored, but only between allowable boundaries (FIG. 1.3). The purpose is to ensure ‘go’ in any cases by providing enough tolerance margins. This method is certainly not helpful for repeatable accuracy and the lack of unique solutions still must be tolerated even in repeated connections of a permanent pair. The alternative way is to introduce compliance into designs. The sprung chassis of an automobile almost always finds a single position solution even on reasonably rough terrains, thanks to the compliance provided by suspension springs and tires. Compliance is the reality at any kinds of contact situations, and it can be actively dealt with as a design parameter.

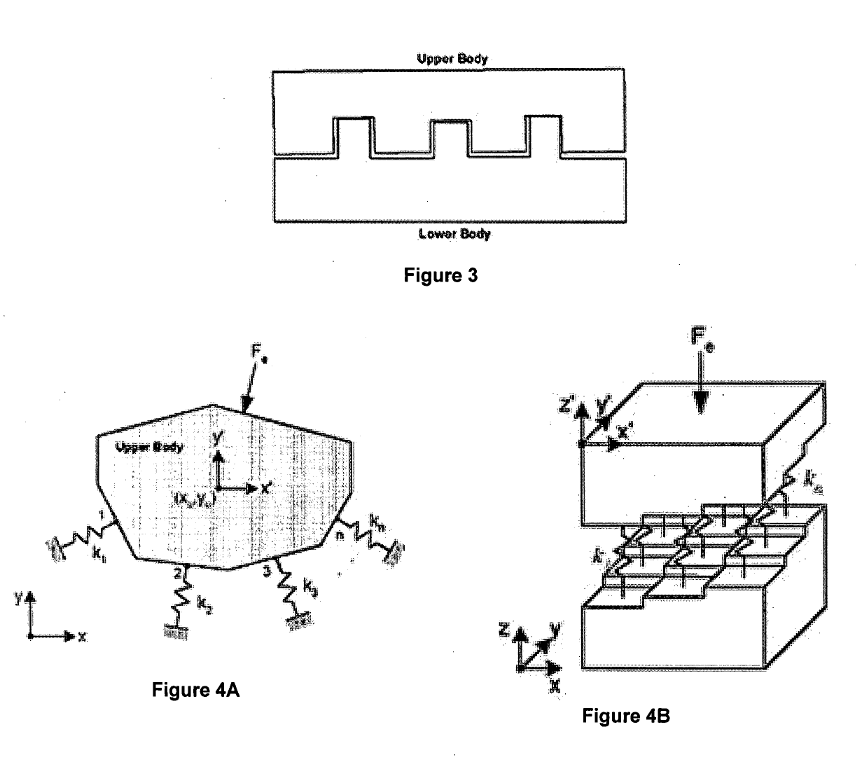

FIG. 3 depicts a connection design with loose tolerances.

Compliance-based designing is a good way of handling geometric variations in those systems that are not necessarily exactly constrained. Because it gives a unique position and orientation solution for a given set of design parameter values, an analytical and deterministic design approach is possible without entirely relying on statistical considerations. In particular, in designing of modular interfaces, deterministic approach allows for simple and straightforward calculations in predicting the connection errors.

In addition, unlike the exact constraining method, compliance-based designing does not limit the designer's choices on the overall geometry and the number of contacts, which is important to meet the requirements for connection stiffness, manufacturing simplicity, volume, weight, etc. To this end, each of the modeling, mathematical formulation and detailed design considerations made in this research is a consistent part of the overall compliance-based designing process for a precision modular interface.

Modeling and Formulation

As previously discussed, when designing connection interfaces for high accuracy, it is necessary to consider all the design variables that have effect over the connection accuracy, including the dimension tolerances, from early phase of the design process. In order to do so, a mathematical tool is needed, which relates all the design variables to the final relative position and orientation of the connection. However, the coupled complexity and nonlinear nature of the multi-point compliant contact situation makes it difficult to obtain the exact closed-form solutions. Although numerical techniques exist to provide for relatively accurate solutions through many discrete steps and iterations, the amount of time and effort required in the associated modeling and solution procedures often make them not necessarily charming in the early design phase. Simple closed-form solutions, even if approximate, can be much preferred in such cases for the ease of calculations and the analytical insights it can bring about.

The objective of this part of the research is to obtain a mathematical formulation to be used to approximate the relative position and orientation of connected modules. Specifically, the contact spring method from the former research is further developed and generalized for multi-dimensional positioning problems. Thus obtained approximate solutions can be used: 1) to find the relative position and orientation of the assembled system with nominal geometries; 2) to find the relative position and orientation of the assembled system with dimension variations; and 3) to find the connection stiffness of the assembled system under workloads.

The mathematical formulation for the position and orientation solution first requires setting up a simplified model of the interface in full connection, composed of the major design variables of local contact compliances, geometry dimensions and dimensional tolerances. Based on rigid-body kinematics, an interface connection can be modeled simply as two rigid bodies connected with a number of linear springs, where each spring represents a local compliance as a combined function of deflections of two mating surfaces in contact (FIG. 1.4). Any deformations at faraway points from the contact surfaces are ignored in this model. The dimension tolerances associated with contact surface locations thus contribute to the degree to which each spring is compressed when connection process comes to the final equilibrium.

FIGS. 4A and B. depict a 2-D and 3-D conceptualization of a connection interface.

Once the model is generated, a linearized single-step solution can be pursued starting from extracting the force equilibrium equations from the model. The overall solution process for an m-DOF problem with n contact springs is to obtain:

m force equilibrium equations

n spring constitutive equations

n-m contact position compatibility equations

and, after rearranging, solve for:

4) m relative position and orientation solutions

5) n contact node positions

6) n contact spring forces.

The compatibility equations describe the positional relationship between different contact points and the reference points of the coupling bodies. Each of the coupling rigid bodies has its own coordinate frame located at its reference point. Since only the relative DOF's are of concern, the lower body is considered fixed in space and only the upper body will have the degrees of freedom to move. The position and orientation of the upper body is determined by the positions of local contact points. The following equations show the simplest form of position compatibility that can be obtained from the connection model.
\vec{p}ᵢ=\vec{p}ᵢ(\vec{p}ᵤ,\vec{θ}ᵤ)

where \vec{p}ᵤ and \vec{θ}ᵤ are the position and rotation vectors of the upper body and \vec{p}ᵢ (i=1, 2, 3 . . . ) is the position vector of the iₜₕ contact point.

Modeling a connection using rigid bodies and contact springs prerequisites a conceptual simplification of an actual local contact into a mathematical contact between two convex polygons. Since the most general single point contact between polygons takes place where a vertex meets a line, an interface connection can be thought of as multiple point-slider joints with added compliance at the tip. The local contact modeling is thus based on the simplification, in which the faces of the convex polygon upper body are mated with pointer edges of the lower body. The assumptions of small relative rotation and relative displacement due to small geometry variations lead to a fully linearized formulation. The contact spring formulations for connections up to three DOF's are developed and presented in Chapter 3 and 4, along with simple tolerance analysis examples.

Interface Design

In the subsequent part of the research, a specific design of modular interface is presented. The purpose of this design work is twofold; 1) to verify the accuracy and usefulness of the contact spring formulation developed in the foregoing part of the research, and 2) to achieve an interface design with a desired accuracy and stiffness that can be used in a particular modular robot system.

Comparisons are made between the results from two different tolerance analyses using the contact spring formulation and FEM results. The FEM model includes: 1) three-dimensional local geometry and overall alignment feature configuration; 2) elastic compliance at the local contact points; 3) frictional effect at the machined contact surfaces; and 4) selected values of dimension tolerances. Although it is expected that the contact spring formulation generally yields good approximations, it is equally important that the actual design be well controlled so that the approximation error can be minimized, since the design and engineering efforts in the subsequent refinement process can be greatly reduced with good initial analytics.

A practical modular interface design should have connection accuracy, stiffness, manufacturing simplicity, ease of assembly, and small weight. One important aspect of connection accuracy is that its initial level should be maintained with repeated connection cycles. For this, contact geometry must be well engineered so that plastic deformation is avoided and the needed amount of elastic compliance is preserved for accurate alignment. Although the accurate alignment is guided by the local contact compliance during a connection process, it is also required that the fully established connection be stiff enough for the workloads. Contact locations must be carefully selected so that the internal force paths through the connections are minimized. Efforts should be exerted to minimize the number of machining operations, since manufacturing simplicity implies reduced number of error sources.

Since accuracy is the principal design specification, the design process begins with specifying the desired connection accuracy value. The radial clamping mechanism such as the one previously designed by UT-RRG (FIG. 1.5) is used, by employing multiple C-shaped wedges and a band clamp, for the convenience and space efficiency it brings. The alignment features for positioning accuracy are also arranged radially on the flat sides of the interface plates, so that two conjugate plates can be axially coupled. The fundamental feature geometry considered in this design is the wedge-groove pair, as in the previous design. The uniqueness of this new design, which discriminates itself from the previous one, is the way it provides precision positional adjustment utilizing local compliance during the connection process.

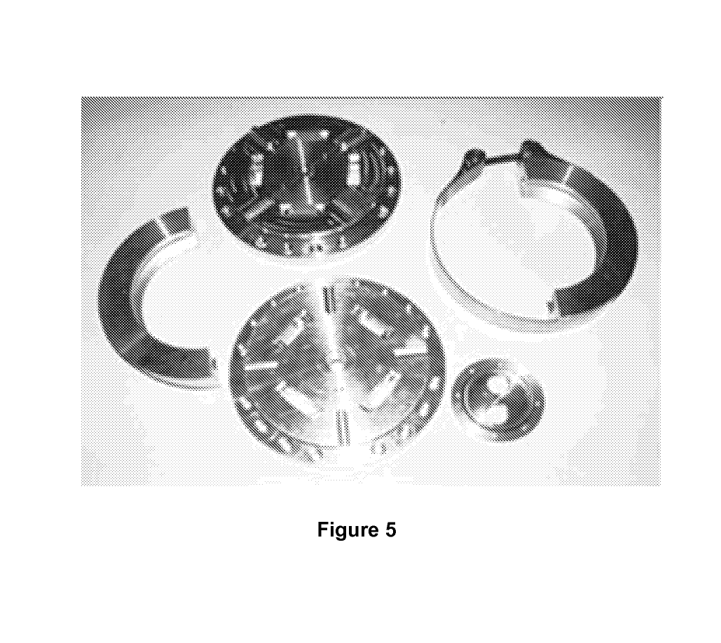

FIG. 5 depicts ALPHA manipulator shoulder module connection interface components

In order to achieve high connection stiffness, complete restraining of all degrees of freedom must be accomplished when the full connection is established. This is made possible by allowing two flat surfaces of relatively large areas to come to a sealing contact at the end of a connection process. The local compliance in the alignment features takes the role only during the connection process. Allowing the large surface sealing contacts not only improves connection stiffness, but, at the same time, it eliminates three degrees of freedom from the relative positioning problem. Proper geometry and machining method must be selected since excellent surface flatness and smoothness is required to avoid any undesirable effects and assure connection accuracy.

In the next part of the design work, a particular error analysis is performed to check the feasibility of applying the contact spring approximation to the given interface design. Since the relative position and orientation of the connection are unique functions of major dimensions and their variations, this task is performed with a set of selected tolerance values based on the design and manufacturing criteria, which is then compared with the corresponding FEM contact simulation results. The purpose of the FEM simulation is to measure the level of agreement between the linear, lumped parameter solution, obtained from the contact spring formulation and the nonlinear solution obtained with friction and the volumetric effect of actual geometry in connection misalignment. The maximum solution difference data obtained after a number of particular error analyses can be a good measure of feasibility in using contact spring model as an accuracy analysis tool for the given design.

Once the use of linear contact spring method is justified, the structural model is actively utilized for stochastic accuracy analysis. Normal distribution of the connection error is assumed in random-pair interface connections. In order for the introduced tolerance and dimension variance values to have correct influences on the connection accuracy, different parameters of simultaneous variations are merged into a single variation parameter, whereas a single parameter containing multiple independent variation sources are decomposed into several child parameters. After the parameter rearrangement process, the local tolerance vector and the local variance vector, obtained from actual machining data, are associated with the system geometry and stiffness matrix to predict the maximum possible ranges of the tolerance errors, the variance of the connection errors, and the approximate 6σ accuracy of the connection.

II. Design Scope

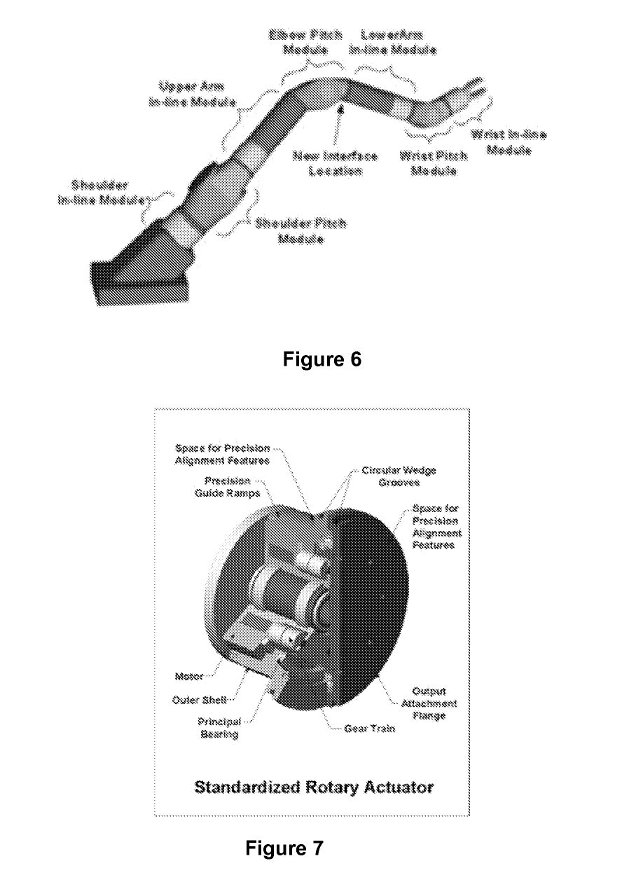

In this chapter, a module connection interface is designed for the ALPHA arm, a seven-DOF modular robot previously designed by RRG of the University of Texas at Austin (FIG. 6.1). Among the modules composing the structure of the ALPHA, the elbow module has been fully fabricated and its performance tested. The elbow module has two interfaces for the in-line connections with the upper and lower arm modules. The design to be presented in this work is the interface to be applied to the elbow module, in place of the previous design of FIG. 1.5 for the connection with the upper arm module. Therefore, the design requirements of the previous design still apply to this work, including the overall size limitations.

FIG. 6 depicts an ALPHA arm module configuration

The new design differs from the previous one in that accurate connection positioning is achieved though the structural compliance in the alignment system, and the effect of manufacturing tolerance on the connection state is taken into the design considerations, thereby providing the expected level of connection accuracy of the final design. The four major design criteria selected for this work are; accuracy, stiffness, configuration, and size. Each of the requirements is discussed below. The design specifications for the ALPHA manipulator are listed in Table 6.1 for reference [23].

TABLE 6.1
ALPHA manipulator specifications

| | |
|---|---|
| Manipulator Reach | 1.83 m (6 ft) Maximum Reach |
| Maximum Payload | 23 kg (50 lb) Continuous, 46 kg (100 lb) |
| | Peak |
| Maximum Speed | 1.27 m/s at End-Effecter |
| Weight | 181 kg (400 lb) Total |
| Repeatability | 0.051 mm (0.002 in) Standard Deviation |
| Accuracy | 2.54 mm (0.1 in) Maximum Deflection |
| Number of Actuated Axes | 7 Rotary (3 Revolute, 4 In-Line) |
| Manipulator Configuration | 3-1-3 DOF (Standard) |
| Level of Granularity | Modular at Joint to Link Interface |
| Primary Structural Material | Aluminum, Metal Matrix Composites |
| Sensor System | Resolvers, Torque Sensors |
| Actuator System | Brushless DC Motors with Braking |

A. Connection Accuracy

As the primary design criterion, the connection accuracy to be achieved through the design should be established first. The needed level of connection accuracy may vary considerably depending on the application of the robotic system under consideration. This means that the target interface accuracy must be balanced with the system's precision level on demand. The two common measures of precision level of robotic systems are the position accuracy and the position repeatability of the end-effecter. The repeatability by and large indicates the precision inherent to the system, whereas the accuracy reflects both the system precision and the coordination between the inner joint space and the outer end-effecter space.

Among the industrial robot systems of relatively large load capacity, repeatability on the order of 0.1 mm is commonly observed. Recent precision robotic equipment for assembly and inspection jobs is gaining 0.01 mm repeatability in light of the development of sensor technology [26]. The accuracy level in robotic systems is generally considered to be one order of magnitude or more greater than the repeatability, placing it in the range between 0.1 mm and 1 mm for precision manufacturing tasks. Some experimental results claim that 0.07 mm accuracy can be achieved [20]. Since it is the geometric configuration of the entire system that the connection error affects during reconfiguration or module interchanges, the ideal connection interface should not allow for significant changes in the positioning accuracy of the system before the reconfiguration.

Guerrero and Tesar [15], in designing the ALPHA manipulator, expressed that achieving a system level accuracy of 0.01 in at the end effecter requires an accuracy of 0.0002 in or better at the component level. This implies, with the currently known accuracy range of industrial robots, that interface connection accuracies between 0.002 mm and 0.02 mm will be considered the desirable accuracy level for modular robots of various applications including precision jobs.

Based on this scaling rule and utilizing the specified end-effecter positioning accuracy of the ALPHA arm of 0.1 in and the length of the wrist module of 0.21 m, the target radial connection accuracy and the target angular accuracy for this design work have been obtained as 0.05 mm or 0.002 in and 50 arc seconds, respectively.

TABLE 6.2
Target connection accuracies

| Radial accuracy | Angular accuracy |
|---|---|
| 0.002 in | 50 arc sec |

B. Connection Stiffness

Hill and Tesar [23] have collected the peak torque, force and moment values for each joint from a structural simulation of the robot for their design criterion values. The values are normalized for comparison in the table below. The relative importance of the load capacity of a joint is determined by the amount of load it carries relative to the maximum load encountered in the arm.

TABLE 6.3
Normalized joint loads in ALPHA manipulator
(Scales: force × 242 N, moments and torques × 160 N-m)

| | Joint 1 | Joint 2 | Joint 3 | Joint 4 | Joint 5 | Joint 6 | Joint 7 |
|---|---|---|---|---|---|---|---|
| Distance from End- | 2.07 m | 1.83 m | 1.63 m | 0.91 m | 0.35 m | 0.21 m | 0.07 m |
| effecter | | | | | | | |
| Forces | 10.0 | 7.2 | 5.0 | 2.8 | 1.7 | 1.2 | 1.0 |
| Moments | 9.6 | 10.0 | 3.8 | 4.4 | 1.3 | 1.4 | 1.0 |
| Joint Torques | 10.0 | 8.8 | 4.5 | 3.7 | 1.5 | 1.3 | 1.0 |

Due to the proximity between Joint 4 and the new interface location, it is assumed that the forces and bending monents of Joint 4 still apply to the new interface location. Also, with the Joint 5 axis being the axis of symmetry of the lower arm, the torsional load at the new interface will be equal to the torque of Joint 5. The target connection stiffness is calculated by dividing each of the loads by the maximum allowable connection deflections in the corresponding directions, which is obtained based on the alowable deflection of the end-effecter due to workloads and the link lengths.

Although the smaller the better, the worst case end-effecter workload deflection is generally allowed to be greater than the rated accuracy of the system, first because the maximum workload deflection is considered as a temporary or transient condition, and secondly because its relative importance depends on the probability distribution of the workloads in the range. Another reason is the practical limitation in the achievable stiffness in robot structures due to other factors such as the material elasticity and weight limitations.

In the structure of a serial robot such as ALPHA arm, load and deflection in bending direction is the most serious problem. Joint bending load is always accompanied by translational joint loads, but the translational deformation is usually very small. Torsional joint loads in robots also normally come from the bending effect in the overall structure resulting from the end-effecter forces, and it is generally safe to assume that maximum joint torsion does not occur with the maximum joint bending. Again, 1/50 of the rated positioning accuracy of ALPHA arm is imposed to the interface for its maximum load deflection in each loading direction. Listed below are the allowable workload deflections and the corresponding stiffness values calculated.

TABLE 6.4
Target connection stiffness

| | Translational | Bending | Torsion |
|---|---|---|---|
| Interface | 152 lbf | 519 ft-lbf | 177 ft-lbf |
| workload | | | |
| Allowable | 0.002 in | 11.5 arcsec | 49.9 arcsec |
| deforma- | | | |
| tion | | | |
| Target | 7.60 × 10⁴ lbf/in | 1.62 × 10⁵ ft-lbf/deg | 1.28 × 10⁴ ft-lbf/deg |
| stiffness | | | |

C. Configuration

Circular, ring-shaped interface geometry is proposed for general modular robot structure. It is naturally compatible with cylindrical cross-sections, which is typically used for motors, actuators, and structural links. With a large value for the inner diameter, the weight can be reduced and the resulting inner space can be efficiently used for power generation, cooling, information and power flows, etc. The space outside the ring geometry is reserved for installation of the clamping mechanism, which adopts the C-clamps and a band spring from the previous design.

A sealing contact between large-area flat surfaces is provided at the end of the connection process to improve the connection stiffness. This way, the compliance in the alignment features performs accurate positioning during the clamping process and the sealing contact provides the enhanced structural support once the connection is complete. Similar attempts have been frequently observed in industry to enhance both position accuracy and stiffness of interfaces of metal cutting machines by providing large face contacts between the tool holder and the spindle. Needless to say, need for bending stiffness is critical in typical robot structures. Proper geometry and machining methods must be selected for excellent surface flatness and perpendicularity with the structural link axis.

FIG. 6.2 shows a concept of standardized modular actuator structure, which demonstrates the flexibility and the reconfiguration efficiency of modular systems complying with the proposed guidelines. The modular architecture allows the single cylindrical standardized actuator to be used in various joint configurations, formed with standard link modules and the clamping mechanism. Each modular link can have circular openings at both ends to provide space to accommodate the cylindrical body of the actuator. Around the circular opening on a flat side of the links as well as on the flat surfaces of the support flange and the output flange of the actuator are the arrangements of the precision alignment features used for accurate positioning and stiff coupling between two modular mating parts.

FIG. 7. depicts a standardized rotary actuator for modular architecture.

The clamping mechanism must be able to provide enough force to hold the modules with good stiffness. The radially applied circular arc shaped wedge clamps (C-clamps) allow for easy connection operation with minimal volume and access space requirements. One practical example of such clamping mechanism applied to a modular robot is the Voss clamp arrangement of the Robotics Research K-1607HP manipulator (FIG. 2.2), which consists of two flanges and a clamping band with two sections. The curved ends of the clamp are seated in the grooves of the flanges to be coupled [6]. This connection enables lightweight attachment and quick, easy disconnection, but it limits the load capacity of the manipulator due to its inherent low stiffness.

The previous interface design of the ALPHA manipulator incorporates a modified version of the Voss clamp arrangement for enhanced stiffness. Two flanges with extends, each attached to a module, are mated together using inner-wedged semicircle clamping members and then a steel band is situated around the outer circumference formed by the clamping members (FIG. 5). Due to the superiority in many practical aspects, this clamping mechanism is continuously used for the new design, with further optimizations in geometry.

D. Size and Material

Overall size of a component must comply with the requirement specifications for the assembled system, since the component size affects the size, volume, and weight of the complete system and therefore imposes limitations to many aspects of the system's performance. This design work is not intended to alter any geometric specifications of ALPHA arm. Hence, the size limitations of the previous interface design will still hold.

At the selected interface location, one member of the interface is attached at the end of the elbow pitch module and the other member fixed at the mating end of the lower arm module. The two modules share the same outer diameter of 7.0 in at the selected interface location, which also makes it the outside diameter of the split circular clamps. Each circular clamp has its thickness of 1.38 in, to fit into the outside space formed by the two interface members whose combined thickness in the connection is 2.2 in. These dimensions work as the size limitations in design.

Unlike the previous design that used aluminum alloy, however, alloy steel 4340 is chosen for the interface material in order to significantly improve the connection stiffness and achieve the target values. Material stiffness and strength are the essential elements for interfaces of high compactness, rigidity, and reliability. It has been decided during the design process that aluminum alloy does not provide the stiffness needed.

The superiority of alloy steel in stiffness and strength also helps to minimize the permanent geometry damages of the alignment features during maintenance operations and the surface damages such as wear and pitting from prolonged use of the interfaces. Although steel has almost three times the density of aluminum, there is only about 62% weight increase in the new interface, partly due to the circular inner space newly introduced to the geometry. Approximate weight comparison with other previous designs is shown below.

TABLE 6.5
Approximate weight comparison of connection interfaces

| | K-1607HP | ALPHA | New |
|---|---|---|---|
| | Interface | Interface | Interface Design |
| Components | Flanges, | Flanges, Wedge clamps, | Flanges, Wedge |
| | Voss Clamp | Band spring | clamps, |
| | | | Band spring |
| Approximate | 6.5 lbf | 8.8 lbf | 14.2 lbf |
| Weight | | | |

E. Clamping Mechanism Design

Since the system of split circular clamps (C-clamps) and band spring has been chosen for the clamping mechanism, the design process starts from analyzing the band spring to obtain the available clamping force. The free-body diagrams of the components from simple symmetric non-friction analysis are shown below. It is assumed that pure tension takes place at the mid-section between both ends of the band spring with the same amount of forces that bolt exerts at the ends. The pre-existing half-circle C-clamp design was used. It is seen that the lateral clamping force transmitted to the inside object through one of the C-clamps has twice the magnitude of the bolt force applied at the ends of the band spring. Therefore, the total magnitude of radial clamping force effective for the subsequent axial clamping is 4 F.

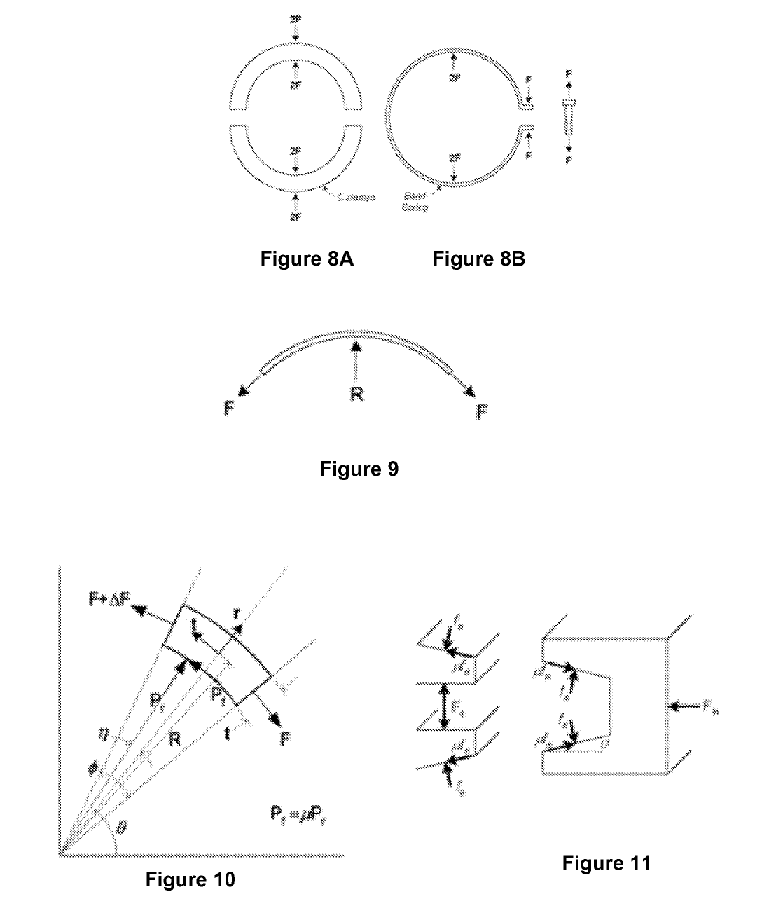

FIGS. 8A and 8B depict simplified diagrams of transverse clamping forces.

For the C-clamps of varying angles of revolution, φ, other than π/2 of the semicircle clamps, the lateral clamping force for a single clamp is calculated as

$${F}_{r} = - 2 F sin ( \frac{ϕ}{2} )$$

under the assumption that the bolt force F produces a uniform tension at all the sections throughout the length of band spring.

FIG. 9 depicts a free-body-diagram of a band spring segment on a C-clamp of arbitrary angle of revolution.

Letting φ be an angle that divides 360 degrees into n segments,

$$\sum {F}_{r} = n \cdot 2 F sin ( \frac{π}{n} )$$

is the total radial clamping force for total of n C-clamps of (2π/n) revolution angle. If infinitely many C-clamps of differential length were employed, the total radial clamping force would be

$$\sum {F}_{r} = {lim}_{n -> ∞} [ n \cdot 2 F sin ( \frac{π}{n} ) ] = 2 π F$$

This would be the case of flexible C-clamp attached to the band spring for its whole length, which may look like a rubber belt with a section profile. Since 2 πF is greater than 4 F, it is beneficial to have more than just two parts of semicircle C-clamps for greater axial clamping force. The semicircle C-clamps are not very efficient in the sense that the radial action of the band spring is all canceled near the ends of the clamps.

In reality, friction can take away a substantial amount of the available forces calculated from a non-friction analysis. Friction plays its role in this band-clamping mechanism as the band spring slips on the outer surfaces of C-clamps when they are bolted together. To consider the possible effect of friction, a slightly different free-body-diagram of a band spring segment is drawn in FIG. 10, which has the angle of revolution of the body, φ.

The underlying assumption in this model is that the supporting C-clamp either does not change its position radially or rotate with the band spring about the origin. This model, therefore, is more suitable to the preloading situation where the relative motion between the parts is minimal. On the other hand, the non-friction model can be valid for the ‘clamp-in’ or ‘wedge-in’ stage, where the C-clamps have some freedom to move. At this stage, the friction between the C-clamps and the band spring doesn't mean much since the C-clamps can still close being firmly attached to the band spring, for the bending flexibility of the band spring.

FIG. 10 depicts a free body diagram of a band spring segment.

Here, the symmetry of the foregoing diagrams no longer exists. The friction force due to the friction coefficient, μ, rotates the radial reaction force by an angle of η from the centerline and also creates the change in sectional tension of the band spring. Performing the force and moment summations in three directions, the following equilibrium equations are generated.

$$\sum {F}_{r} : - ( F + Δ F ) sin \frac{ϕ}{2} - F sin \frac{ϕ}{2} - μ {P}_{r} sin η + {P}_{r} cos η = 0$$

$$\sum {F}_{t} : - ( F + Δ F ) cos \frac{ϕ}{2} + F cos \frac{ϕ}{2} - μ {P}_{r} cos η - {P}_{r} sin η = 0$$

$$\sum {M}_{z} : - R ( F + Δ F ) + RF - ( R - \frac{t}{2} ) μ {P}_{r} = 0$$

This is a system of nonlinear equations and only numerical solutions can be obtained. Solving the last equation for ΔF,

$$Δ F = - \frac{( R - t / 2 ) μ {P}_{r}}{R} \qquad ( 6.1 )$$

Substituting this into the first and second equations, we obtain the following equations to solve.

$$\sum {F}_{r} : \frac{( R - t / 2 ) μ {P}_{r}}{R} sin \frac{ϕ}{2} - 2 F sin \frac{ϕ}{2} + {P}_{r} ( cos η - μ sin η ) = 0$$

$$\sum {F}_{t} : \frac{( R - t / 2 ) μ {P}_{r}}{R} cos \frac{ϕ}{2} - {P}_{r} ( sin η + μ cos η ) = 0$$

Introducing the geometry constants, t, R, φ, and the friction coefficient, μ, into the above two equations, η and Pᵣ can be solved for, which will then provide ΔF value from Equation (6.1). The band thickness of 0.1″ and the C-clamp outer diameter of 6.8″ of the previous design are borrowed since the same overall dimension requirements apply to this design. The static friction coefficient of μ=0.74 for dry steel-on-steel friction is used. Two sets of solutions exist for every input sets. The physically reasonable solutions are collected for different φ's and listed in the Table 6.6.

TABLE 6.6
Radial clamping force calculation result

| | φ | | | | | |
|---|---|---|---|---|---|---|
| | 180 deg | 120 deg | 90 deg | 60 deg | 45 deg | 30 deg |
| η | −36.5 deg | −19.5 deg | −12.0 deg | −6.00 deg | −3.72 deg | −2.02 deg |
| ΔF/F | −0.7390 | −0.6936 | −0.6259 | −0.5076 | −0.4212 | −0.3108 |
| Pᵣ/F | 1.014 | 0.9512 | 0.8583 | 0.6962 | 0.5777 | 0.4263 |
| ΣPᵣ/F | 2.028 | 2.854 | 3.433 | 4.177 | 4.622 | 5.116 |

The result reveals that for the semicircle C-clamps, the total amount of radial clamping force drops from 4 F to 2 F with the effect of friction, which is a 50% reduction in the available force. It is also observed that, as the angle of revolution gets smaller, the effect of friction diminishes and the normalized total radial clamping force approaches the 2 πF, previously obtained from the non-friction analysis. This is another indication that using increased number of shorter C-clamps can be beneficial.

The width of the band spring form the previous design was 1.0″ and significant increase in this value is not intended as an effort to satisfy the overall dimensional requirement. This width imposes a limitation to the available sizes of bolts for clamping. Inch series bolts of the reasonable sizes for this application are considered below in Table 6.7. These selections were made based on the condition that at least two bolts will be used together in the allowable space.

The initial tensions for bolts, Fᵢ, are commonly calculated according to the equation,
Fᵢ=KᵢAₜSₚ

where Aₜ is the tensile stress area of the thread, Sₚ is the proof strength, and Kᵢ is the safety factor [29]. For ordinary applications involving static loading, Kᵢ is normally 0.9. Since robots are exposed to moderate level of dynamic loads, Kᵢ=0.8 is used for this calculation.

TABLE 6.7
Coarse thread unified screw bolts

| Dia (in) | Aₜ (in²) | SAE grade | Sₚ (ksi) | Fᵢ (lbf) |
|---|---|---|---|---|
| 0.250 | 0.0318 | 1 | 33 | 839.5 |
| | | 2 | 55 | 1399.2 |
| | | 5 | 85 | 2162.4 |
| | | 7 | 105 | 2671.2 |
| | | 8 | 120 | 3052.8 |
| 0.3125 | 0.0524 | 1 | 33 | 1383.4 |
| | | 2 | 55 | 2305.6 |
| | | 5 | 85 | 3563.2 |
| | | 7 | 105 | 4401.6 |
| | | 8 | 120 | 5030.4 |
| 0.3750 | 0.0775 | 1 | 33 | 2046.0 |
| | | 2 | 55 | 3410.0 |
| | | 5 | 85 | 5270.0 |
| | | 7 | 105 | 6510.0 |
| | | 8 | 120 | 7440.0 |

In order to calculate the axial clamping force using these bolts, the wedge angle of the C-clamps and their wedging mechanism must be known. Kinematically, greater wedging effect is achieved for smaller wedge angles. However, other considerations must be made when choosing the angle, such as stick-slip condition due to surface friction, closing distance and stress concentration. The self-stick condition essentially results in interference fits, which creates difficulty in maintenance process by requiring special separation tools for disengaging the parts. From the structural point of view, small wedge angles are not desirable since they not only lead to long and narrow geometry that can concentrate stress at the base, but also they are more susceptible to accidental overloading and excessive part deformations.

The free-body-diagram of an arbitrary C-clamp section in equilibrium with the two coupling body wedges and the band spring can be drawn as below.

FIG. 11 depicts a force equilibrium in wedging with friction.

Having the wedge angle defined with θ, the horizontal equilibrium equation about the C-clamp section during the wedge-in process is
2Fₙ sin θ+2μFₙ cos θ=Fᵢₙ

The second term of the left-hand-side is the contribution of the friction force, and its sign is subject to change to oppose the current tendency for sliding motion. If the C-clamps are released from pushing at the end of a wedging process, the resisting force between the clamped coupling bodies, F_{c}, will try to ‘back-drive’ the wedge mechanism and push the C-clamps out. Because it is the friction that opposes this attempt by changing its direction under the self-stick condition, the above equation becomes,
2Fₙ sin θ−2μFₙ cos θ=0

Solving for μ, the self-stick condition is obtained as
θ=tan⁻¹μ

For steel-on-steel contacts, the wedge angles that initiate self-stick condition were calculated using various friction coefficients [46] and listed in Table 6.8. The result shows that, for dry connections, the wedge angle should be greater than 37 degrees to have a wedging effect by overcoming the static friction. Since this is a relatively large angle for a good force amplification ratio, it has been decided that lubrication will be used in the assembly process. This allows for reasonable wedge angles as low as 10 degrees.

TABLE 6.8
Prismatic wedge angles of self-stick condition

| | | |
|---|---|---|
| Dry contact | μₛ = 0.74 | θ = 36.5 deg |

| | |
|---|---|
| μₖ = 0.57 | θ = 29.7 deg |

| | | |
|---|---|---|
| Wet contact | μₛ = 0.16 | θ = 9.1 deg |
| (Lubricated) | | |

| | |
|---|---|
| μₖ = 0.06 | θ = 3.4 deg |

For prismatic wedges of straight edges, the force amplification ratio is simply a function of the wedge angles. The same thing would apply to C-clamps if clamping could be performed through radial contraction of the geometry. If this were possible, the clamping load would be uniformly distributed over the entire circumferential length of the clamps. Since this is not the case, careful observation is needed to account for the difference between the cylindrical geometry and its linear clamping path. The clamping process of a C-clamp can be divided into two parts. The first part is the ‘wedge-in’ process that continues until the clamp arrives to its fully engaged position. Once this configuration is reached, the macro-scale relative motion between the C-clamp and the coupling bodies ends and the ‘preloading’ part begins. Until the first part is completed, the designated mating surfaces of the C-clamps and the mating body wedges do not come to their full contacts. In fact, it is only the far-end edges of the clamps that maintain contact through most part of the first wedging process. The wedging effect in this first clamping part, therefore, comes from sliding the C-clamp end edges on the wedge surfaces of the coupling bodies, but nearly in the transverse direction or tangential direction of the curved wedges. The effective wedge angle is very small for that reason.

Towards the end of the first clamping part, the contact region rapidly grows all the way to cover the entire length of the C-clamp, and this configuration is maintained mostly through the second clamping part. Despite the fully engaged contact condition, the amount of wedge effect varies along the length of the C-clamp. Unlike the first clamping part where most of the load was concentrated at the clamp ends, the second clamping part distributes the entire preload around the mid-section of the C-clamp. The equilibrium condition of the second clamping part is shown in the next figure with half of the clamp.

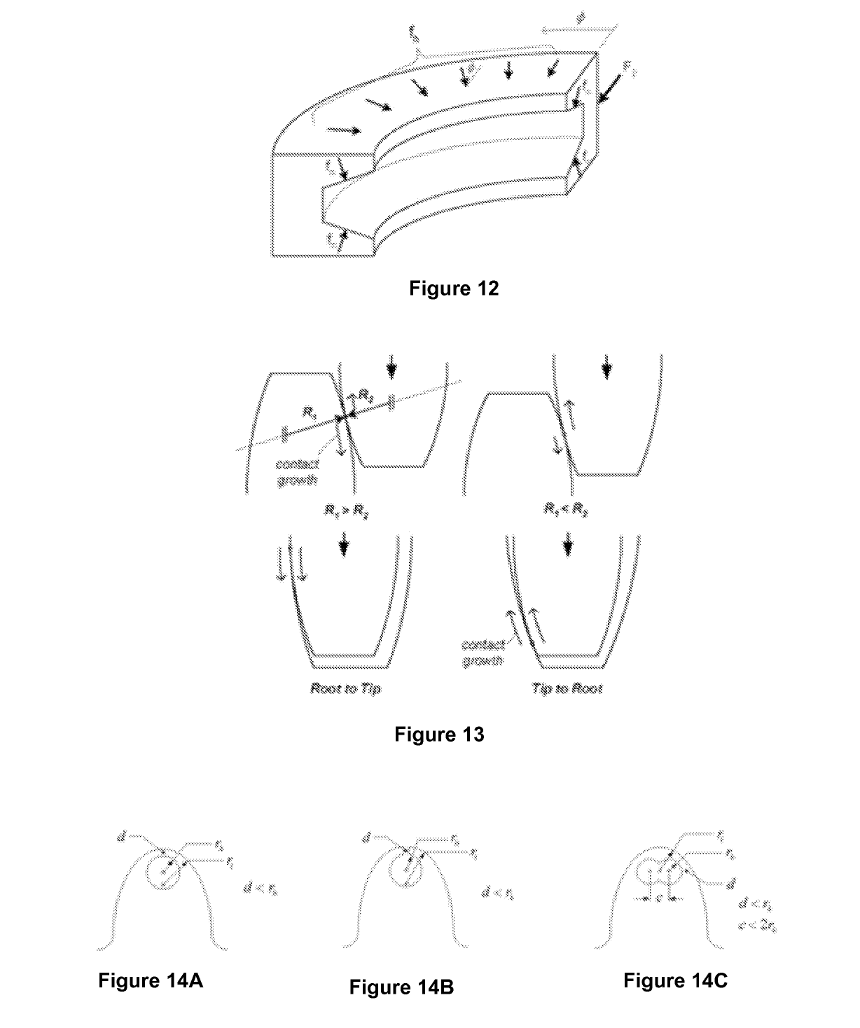

FIG. 12 Symmetric half of a C-clamp of angle of revolution, φ.

Without friction, the axial reaction force, F₁, and the laterally applied force, F₂, are calculated for the given angle of revolution of the C-clamp, φ, by

$${F}_{1} = {\int }_{0}^{l} {f}_{n} cos θ ⅆ l = 2 \cdot {\int }_{0}^{ϕ / 2} {f}_{n} r cos θ ⅆ ϕ = {f}_{n} r ϕ cos θ$$

$${F}_{2} = 2 \cdot {\int }_{0}^{l} {f}_{h} cos ϕ ⅆ l = 4 \cdot {\int }_{0}^{ϕ / 2} {f}_{n} r sin θcos ϕ ⅆ ϕ = 4 \cdot {f}_{n} r sin θ sin \frac{ϕ}{2}$$

where r is the radius of the contact circle formed by the normal forces, fₙ, Solving one equation for fₙ, we get

$${f}_{n} = \frac{{F}_{1}}{r ϕ cos θ}$$

and plugging it into the other, the force amplification ratio is obtained as

$$\frac{{F}_{1}}{{F}_{2}} = \frac{ϕ cos θ}{4 \cdot sin θ sin \frac{ϕ}{2}}$$

which is a function of both θ and φ. For a semicircle C-clamp of φ=π, the lateral clamping force in the above equation is equivalent to that of a prismatic clamp of whose length of extrusion is equal to the C-clamp diameter, given the same pressure on the clamped surfaces. Yet, because of the difference in the total vertical force acting over the whole length, the semicircle clamp has greater force amplification ratio than the prismatic clamp. This gain attributes to the fact that a curved clamp has some structural clamping that does not require external clamping force.

Friction creates tangential forces on the wedge surfaces, acting in any direction closest to the motion of the C-clamps relative to the coupling bodies. Its direction is therefore the clamp-in direction projected to a point on a circular wedge surface. The friction play changes the above equations into the following.

$$\begin{matrix}{F}_{1} = {\int }_{0}^{l} [ {f}_{n} cos θ - μ {f}_{n} sin ( θ cos ϕ ) ] ⅆ l \\ = 2 r \cdot {\int }_{0}^{ϕ / 2} [ {f}_{n} cos θ - μ {f}_{n} sin ( θ cos ϕ ) ] ⅆ ϕ\end{matrix}$$

$$\begin{matrix}{F}_{2} = 2 \cdot {\int }_{0}^{l} [ {f}_{n} cos ϕ + μ {f}_{n} cos ( θ cos ϕ ) ] ⅆ l \\ = 4 r \cdot {\int }_{0}^{ϕ / 2} [ {f}_{n} sin θ cos ϕ + μ {f}_{n} cos ( θ cos ϕ ) ] ⅆ ϕ\end{matrix}$$

The factors sin(θ cos φ) and cos(θ cos φ) give the vertical and horizontal components of the friction force μfₙ as functions of both θ and φ. The solutions of the force amplification ratio, F₁/F₂, from the above equations are provided in Table 6.9 for three different wedge angles of θ and four angles of φ.

Based on these ratios, the total axial clamping forces can be calculated now. First, the initial bolting forces of the selected three sizes of bolts are multiplied by the number of bolts of two, and also by the ratio of radial clamping force to bolting force found in Table 6.6 for the corresponding angles of revolution. Since there are multiple C-clamps in a module connection, the above calculation must be performed on each of the members by accounting for the differences in band spring tension applied to different clamping members in series. These differences can be calculated using the ΔF values of Table 6.6. Those members having symmetric boundary condition can be divided into two members of half of their angles of revolution for ease of calculation.

TABLE 6.9
Force amplification ratio calculation result

| F₁/F₂ | φ = 180 deg | φ = 120 deg | φ = 90 deg | φ = 60 deg |
|---|---|---|---|---|
| θ = 10 deg | 1.796 | 1.593 | 1.526 | 1.481 |
| θ = 20 deg | 1.213 | 1.024 | 0.9676 | 0.9286 |
| θ = 30 deg | 0.8713 | 0.7154 | 0.6695 | 0.6388 |

These radial forces are then multiplied by the force amplification factors of Table 6.9 for the selected wedge angles and the angles of revolution of the C-clamps. Summation of these values calculated for all the C-clamp members employed in a connection clamping yields the total axial clamping force available for the next design of the local geometries. The solutions for the selected set of parameter values are listed in Table 6.10. Three different angles of revolution were considered: 180, 120, and 90 degrees. Smaller angles were discarded because the number C-clamps used in a connection operation was limited to four regarding the ease of assembly and maintenance.

Given the same wedge angle and bolt diameter, the variation in axial clamping force with varying angles of revolution came out to be relatively small, despite the greater total radial clamping forces with smaller angles of revolution. This similarity occurs because the opposite variation in force amplification ratio of the C-clamps cancels off the effect of variation in radial clamping force. Nonetheless, the effect of changing the angle of revolution on the total axial clamping force seems to be growing gradually with the increasing wedge angle. The angle of revolution associated with the maximum clamping force changes from φ=120 degrees to φ=180 degrees as the wedge angle changes from 10 degrees to 20 degrees.

TABLE 6.10
Total axial clamping force with single bolt use

| | | Angel of revolution | | | |
|---|---|---|---|---|---|
| Wedge | Bolt dia. | 180 deg | 120 deg | 90 deg | |
| angle, θ | (SAE 8) | (n = 2) | (n = 3) | (n = 4) | |
| 10 deg | ¼″ | 11116.1 lb | 11326.4 lb | 10988.6 lb | A × Axial |
| | ¼″ | 11116.1 lb | 11326.4 lb | 10988.6 lb | clamping force |
| | 5/16″ | 18317.1 lb | 18663.5 lb | 18106.9 lb | (n members) |
| | ⅜″ | 27091.1 lb | 27603.5 lb | 26780.3 lb | |
| 20 deg | ¼″ | 7506.7 lb | 7280.7 lb | 6967.6 lb | |
| | 5/16″ | 12369.5 lb | 11997.2 lb | 11481.2 lb | |
| | ⅜″ | 18294.6 lb | 17743.9 lb | 16980.8 lb | |
| 30 deg | ¼″ | 5394.4 lb | 5086.6 lb | 4821.0 lb | |
| | 5/16″ | 8888.7 lb | 8381.6 lb | 7944.0 lb | |
| | ⅜″ | 13146.5 lb | 12396.5 lb | 11749.3 lb | |

A good selection of the angle of revolution is not obvious in this analysis of axial clamping force. However, it has been shown earlier that using larger number of C-clamps of smaller angle of revolution allows for greater total radial clamping force with less radial force contribution from individual C-clamps. The smaller the radial clamping load on each clamp is, the easier it is to remove each member from the connection assembly. On the other hand, minimizing the number of necessary parts is also beneficial from maintenance and assembly point of view. Also, smaller angle of revolution helps reducing the possible bending deformation of the circular arc shape of the C-clamps during the assembly process, which may reduce the clamping efficiency.

Considering the 1.0″ width of the previous band spring design, using two ¼″ size bolts is ideal. Single 5/16″ or ⅜″ is also suitable. Double ⅜″ bolts may be used if the band width is increased at least by 30% for other reasons. In terms of the rated proof load of the bolts, two ¼″ bolts are stronger than one 5/16″ bolt and two 5/16″ bolts are better than one ⅜″ bolt. It is therefore reasonable to choose to use two ¼″ bolts for clamping as an initial design selection.

Wedge angle of the C-clamp is selected based on three criteria: 1) resulting force amplification ratio or total axial clamping force, 2) the self-stick condition and 3) stress concentration. The minimum wedge angle of a C-clamp to avoid the self-stick condition in the fully engaged state is obtained from the equation
∫₀^{φ/2}[sin θ cos φ−μ cos(θ cos φ)]dφ=0

which is a function of μ and φ, obtained from Equation 6.2. For μ=0.16, the wedge angles for varying angle of revolution obtained from numerical solutions are shown in Table 6.11.

TABLE 6.11
Minimum wedge angles to avoid self-stick condition

φ (deg)

| | 180 | 120 | 90 | 60 | 45 | 30 |
|---|---|---|---|---|---|---|
| θ (deg) | 14.33 | 11.04 | 10.18 | 9.60 | 9.41 | 9.27 |

The minimum wedge angle for the 120 degrees angle of revolution of the previous interface design has been calculated as 14.3 degrees. For smaller angles of revolution, the wedge angle asymptotically approaches 9.1 degrees of the prismatic wedge presented earlier in Table 6.8. Selecting the natural numbers closest to the big three wedge angles in the table, the available axial clamping forces are as follows.

TABLE 6.12
Clamping force comparison

| | | | |
|---|---|---|---|
| Angle of Revolution | 180 deg | 120 deg | 90 deg |
| Wedge angle | 15 deg | 12 deg | 11 deg |
| Force amplification ratio | 1.459 | 1.443 | 1.448 |
| Total axial clamping force | 18065.6 lb | 20519.7 lb | 20853.8 lb |

Both φ=120 and φ=90 cases yield the total axial clamping forces of nearly equal magnitude, which are slightly over 20,000 lbs. The choice among the above combinations is the one that gives the best axial clamping force, ease of assembly operation, and better stress distribution, which is the middle column set of φ=120 degrees and θ=12 degrees.

F. Local Alignment Design

Having established the available total axial clamping force, the next design step is to generate an initial design of the local contact geometry. The required clamping force to fully close all the local contact pairs of the interface must be sufficiently smaller than the available clamping force for providing enough preload on the major contact surfaces of the connection. There are following six major parameters associated with local contact geometry design.

1. Overall tooth profile

2. Angle of contact

3. Tooth height

4. Tooth depth

5. Tooth stiffness

6. Number of tooth pairs

Each of these design parameters is coupled with other parameters one way or another. Tooth profile constrains tooth height and tooth thickness together. Tooth height and tooth depth are linked together through the tooth stiffness. Number of teeth has to do with overall connection stiffness, which is also based on local tooth stiffness. Angle of contact and tooth height together determine either required tooth deflection or allowable stress. Other factors also contribute to the design of the tooth geometry, such as ease of manufacturing and robustness in characteristics against manufacturing tolerances.

Determination of the overall geometry begins with selecting the mechanics of local compliance. As discussed in the previous chapter, the two kinds of mechanisms considered for modular robot connections include contact compliance and structural compliance. Contact compliance is normally used for small deflections against large loads. Geometry can be simple, but requires good control over surface curvature and smoothness. Too small loads can easily cause lost contacts in contact pairs of over-constrained connections and too small curvatures can cause excessive stress even under moderate loads.

In contrast, structural compliance, which is often implemented with beam springs, allows for relative large deflections with smaller loads. If these springs are made with relatively stiff materials such as metals, they may require large dimensions to result in long force transmission paths to satisfy specified deflections. Due to their geometric characteristics, stress concentration can be a major limiting factor in design. Since more parameters are needed to define the geometry when compared to contact compliance springs, care must be provided to minimize the sensitivity in stiffness and stress on manufacturing tolerances.

There are different options in choosing contact tooth geometry. The contact can be convex-concave, convex-convex, or convex-flat. The flat-flat option also exists, but it should be avoided for better force-deflection controllability as discussed earlier. To minimize parameters associated with the surface shape, the concave or convex surfaces can be defined with two radii in three dimensions, or even with single radius in the vicinity of the contact points. In FIG. 6.8, several possible combinations of such contact surfaces are illustrated.

In the convex-convex contacts, the radius of either one of the teeth may be bigger than the other, and the contact point tends to migrate in the direction of relative motion of the tooth of smaller radius as the contact area grows. The rate of contact position change is a function of the ratio between the two radii. If the radius of one tooth is infinitely large, the contact position simply moves with the tooth of small radius, whereas if the ratio of the radii is unity, the contact position remains the same. In convex-concave contacts, the radius of the convex tooth is always smaller and the direction of contact growth is dependent on the initial contact position as shown in the lower diagrams of FIG. 6.8. Due to the increased conformity between the surfaces, the contact growth rate is higher than in the convex-convex contact cases.

Among the contact cases shown, the convex-convex cases are in better condition for utilizing contact compliance. For structural compliance with bending, the root-to-tip case of the convex-concave couple won't be an ideal condition because the root-side loading is not very effective to induce bending and also because the tooth rotation from the bending will tend to keep the separation at the tooth tip. The rolling effect from tooth rotation exists in other cases, but should be rationally small for small bending levels.

FIG. 13 depicts a circular arc teeth contact configurations

In some cases, mixed use of both contact compliance and structural compliance or use of layered compliance of either kind may be necessary. The following figure is a gear tooth concept employing extra compliance at the tooth tip by having an open slot. Although ordinary gear teeth have generic bending and contact compliance, this added compliance may be used to maintain or even enhance contact ratios of certain multiple contact gear trains under the effect of manufacturing tolerances. The small beam spring of a male tooth can be utilized during the initial contact of the tooth with the side of a female tooth.

FIG. 14 depicts gear teeth with added tip compliance

In this work, the local contact geometry is designed to utilize structural bending compliance. Designing with structural compliance has the following strong points: 1) large deflection can be achieved with limited applied closing loads, 2) more freedom is allowed to the overall configuration of local spring arrangement, and 3) beam geometry can be manufactured relatively easily compared to three-dimensional curvatures.

The superior freedom in achievable deflection can be helpful in designing to maintain contact engagement with geometric variations. The two-dimensional beam profiles can be composed of either curvatures or straight line segments. Either way, those beam springs can be cut or ground using a general-purpose milling machine if the precision requirement is not too severe. Three-dimensional curvatures are difficult to shape on a part in general. There are certain ways of generating three-dimensional precision curvatures such as helical gears and Curvic couplings, but such methods significantly limit the designer's freedom in configuration management or overall arrangement of individual tooth pair meshes.

It has been discussed that position and direction of a local contact can be best known when a three-dimensional convex surface meets a flat surface. This is an important point in designing for good accuracy control. In this design, this point is slightly relieved as a trade off for the geometric simplicity, by designing a prismatic beam of uniform two-dimensional profile. This makes the local coupling pairs form line contacts instead of point contacts. Obviously, line contacts are associated with uncertainty in actual contact location along the length of the contact. It is therefore important to minimize this shortcoming by choosing a spring depth small enough compared to the overall dimension of the spring arrangement area. For an interface of circular local spring arrangement, the spring depth may be compared to the diameter of the beam spring circle. A rule of thumb for this condition can be,

$$\frac{Beam spring depth}{Beam spring circle diameter} \leq 0.1 \qquad ( 6.1 )$$

which limits the beam depth for this application to not much greater than 0.4″ since the beam circle will be located just outside the center hole of 4.0″ diameter.

The contact teeth are arranged along the tooth circle of each coupling body in such a way that, symmetric tooth sets, formed by two beam teeth closely placed back-to-back, are distributed with even spacing. The thickness of these tooth sets determine the maximum number of tooth sets that can fit along the tooth circles of both coupling bodies. If both coupling bodies share a uniform thickness for the tooth sets and the grooves, the following relation holds among the tooth set thickness, total number of tooth sets employed in one coupling body, N, and the tooth circle diameter D.

$$Tooth set thickness \leq \frac{π D}{2 N} \qquad ( 6.2 )$$

The baseline geometry of the local bending spring is obtained through a fully stressed beam analysis using Equations (5.1) through (5.3). The following plot shows the shape of the fully stressed beam that achieves 0.0018 in tip deflection with 30% margin of safety with reference to the yield strength of steel 4340.

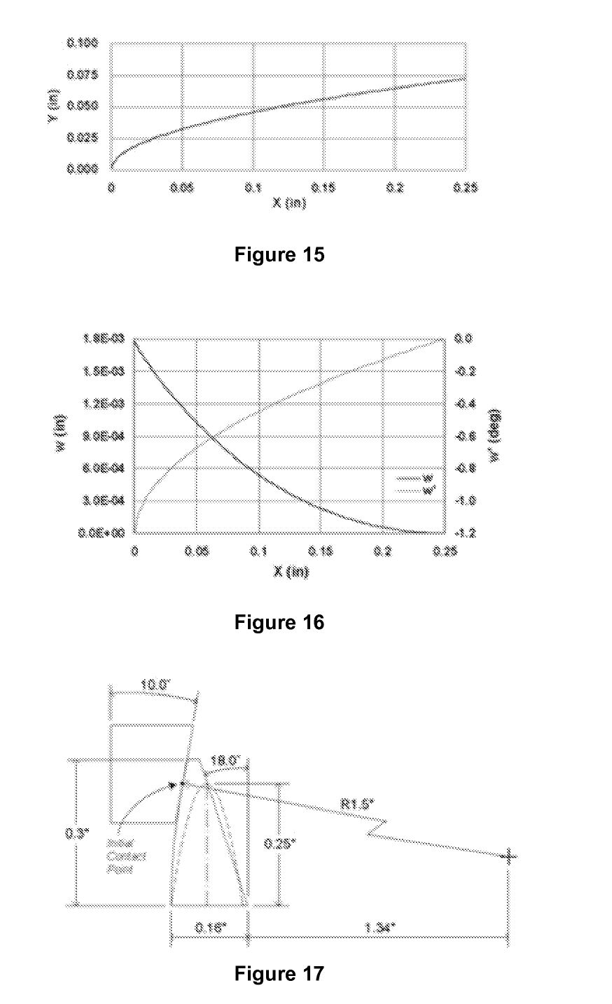

FIG. 15 depicts a fully stressed beam profile with F=89.0 lb and σ=92.4 ksi.

A single beam of this profile is 0.25″ long and 0.144″ thick. The length has been limited to 0.25″ so the final modified tooth does not exceed 0.3″ in length. The designed tooth has the depth of 0.2″ in the direction of protrusion, and this satisfies the imposed condition of Equation (6.1) with the ratio of 0.05. A tooth set comprising two of these teeth will have the total thickness greater than the thickness sum of the two teeth. Although Equation (6.2) gives 20 tooth sets as maximum for each coupling body, use of 16 tooth sets is reasonable for practical considerations such as corner fillet lengths. The deflection and slope variation along the length of the beam under the 257.2 lb tip loading is obtained using the corresponding formula derived in Chapter 5, and plotted in FIG. 6.11.

FIG. 16 depicts deflection and slope of fully stressed beam

With the calculated 0.0018″ maximum deflection of the beam, the tip slope reaches an angle of 1.2 degree. This deflection is equivalent to 0.01″ axial relative approach distance when clamped on a rigid groove surface of 10-degree wedge angle and μ=0.16 from Table 6.7, under the effect of 89.0 lbf clamping force. For 16 tooth sets or 32 teeth in this bending condition, the total clamping force required is 2,848 lbf, which is well below the available clamping force of 20,520 lbf from the band clamping analysis. The bending stiffness of each tooth is 144,840 lbf/in. The fully stressed beam just discussed is summarized below.

TABLE 6.13
Summary of the fully stress beam baseline tooth

| Length | Depth | Thickness | Tip load | Deflection | Stress | Stiffness |
|---|---|---|---|---|---|---|
| (in) | (in) | (in) | (lb) | (in) | (ksi) | (lb/in) |
| 0.25 | 0.2 | 0.144 | 257.2 | 0.00178 | 92.4 | 144,840 |

Using the baseline tooth shape obtained above, a modified tooth geometry is generated by considering the compatibility with the selected contact angle and contact position. In order for the calculations made on the fully stressed beam to be valid, the beam must be loaded at the tip. This condition must be met while satisfying the contact angle of 10 degrees chosen for the lubricated steel-on-steel contacts, using the tooth geometry analytically defined. The modified solution is shown below in FIG. 6.12.

Figure depicts fundamental local contact geometry

The total length of the tooth has increased to 0.3″, and the extra 0.05″ length has been used to keep the continuity near the contact point, which is located at the height of the baseline tooth. The contact side of the tooth is defined with a circular arc, and the other side is defined with a straight line. Through this modification, both the thickness of each horizontal cross-section and the total area up to the contact level are maintained close to those of the baseline tooth shape.

After this stage, the baseline beam spring is further modified into the final design for manufacturing. The continuity between a tooth and the tooth foundation and also between two neighboring teeth is the main issue for both ease of manufacturing and the stress relief at the bending root. The fillet radius is selected so that the stress level is minimized and the stress distribution is maximized for a given deflection range, while maintaining the designed stiffness level. The modified tooth shape has its outside fillet radius of 0.1″ and the between-the-teeth radius of 0.5″.

Two-dimensional stress distribution of the modified tooth geometry is checked through an FEM contact analysis. The upper body is pushed at the top to have 0.01″ pure vertical translation from the initial contact configuration, while holding the lower tooth at its base. The upper tooth is refrained from bending due to the infinite continuity condition on the left side. Both of the contacting bodies are made of steel 4340, and the friction of μ=0.16 is applied at the contact surfaces.

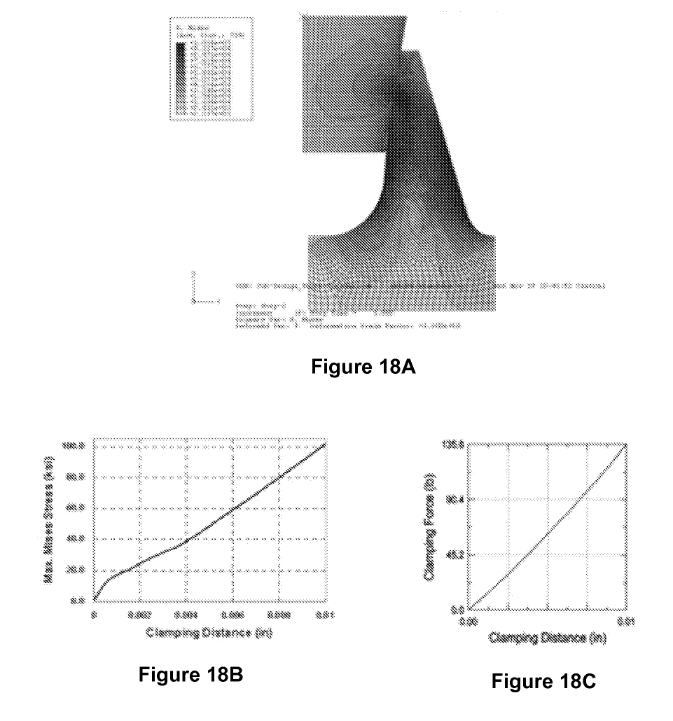

FIGS. 18A-18C depict stress distribution of modified local contact couple.

At the 0.01″ axial deflection, the maximum Mises stress reaches 101.6 ksi. At the fully connected state, the contact point must be located half way between the initial contact point and the point of maximum allowable stress in order to be equally away from both loss of contact and plastic deformation of teeth under the effect of tolerances. Because plastic deformation results in permanent tooth damage unlike the loss of contact, provision of some safety margin is necessary.

Several tolerance definitions are being used to specify the geometric variations of manufactured gears. In each definition, the level of tolerances depends on the overall gear size and the needed manufacturing precision indicated by the AGMA quality number. Commonly used gear tolerance definitions include pitch tolerance, runout tolerance, center distance and composite center distance tolerances. Among them, the pitch tolerance of face gears can be a good reference in predicting the effects of tolerances on the interface connection, considering the analogy in the overall configuration between the two devices.

To see the tolerance effect on the stress of the alignment teeth in contact, the pitch tolerance of bevel gears of the comparable size is introduced as horizontal relative position variation at the contact between the two teeth. Assuming that the same tolerance applies to both the upper and lower bodies, the horizontal position of the upper body of the FEM model is varied by double the magnitude of the corresponding tolerance value. From the AGMA bevel gear tolerance table 1 [34], the tolerance values for pitch diameter of 5″ and the diametric pitch of 4 in⁻¹ are used for the AGMA quality numbers 6 through 13 of the ‘high precision’ class gears [49].

The same AGMA tolerance values can also be applied to examine the sensitivity of the tooth stiffness on the geometry variation due to manufacturing tolerances. In the model, the contacting side surface of the lower body tooth is repositioned horizontally with reference to the other side surface by double the magnitude of the corresponding tolerance values to recalculate the effective stiffness. The results from these analyses are listed in Table 6.14. The nominal values of maximum stress and contact normal stiffness are 48.8 ksi and 2.36×10⁵ lbf/in.

The maximum stress varies considerably with the tooth position variations as the AGMA quality number shifts from 13 down to 6. From Qᵥ=7 and below, the stress goes beyond the elastic limit of 4340 steel for the forced vertical displacement of 0.005″. In contrast, the effect of the tolerance on tooth stiffness is relatively mild, as expected. With their percent variations less than 5%, the local stiffness may be reasonably treated as a constant property for the tolerance range shown. Note that these calculations represent the worse case situations because the limiting tolerance values were used and the global error averaging effect was not counted.

TABLE 6.14
Stress and stiffness for varying pitch tolerance

| AGMA | | Maximum | Percent | Stiffness | Percent |
|---|---|---|---|---|---|
| quality | Pitch | stress | change | variation | change |
| number | tolerance (in) | (ksi) | (%) | (lbf/in) | (%) |
| 6 | 0.0022 | 199.3 | 308.3 | ±0.117 × 10⁵ | ±4.96 |
| 7 | 0.0016 | 154.4 | 216.3 | ±0.084 × 10⁵ | ±3.57 |
| 8 | 0.0011 | 119.1 | 144.0 | ±0.059 × 10⁵ | ±2.48 |
| 9 | 0.0008 | 99.0 | 102.8 | ±0.042 × 10⁵ | ±1.78 |
| 10 | 0.0006 | 85.9 | 76.1 | ±0.032 × 10⁵ | ±1.34 |
| 11 | 0.0004 | 73.2 | 50.0 | ±0.021 × 10⁵ | ±0.89 |
| 12 | 0.0003 | 67.0 | 37.3 | ±0.016 × 10⁵ | ±0.69 |
| 13 | 0.0002 | 60.8 | 24.6 | ±0.011 × 10⁵ | ±0.45 |

Once the modified geometry of the local contact pair is obtained, preliminary tolerance analyses can be conducted using either the formulation presented in this work or the finite element analysis method. Finite element analysis can provide more accurate solutions than the lumped parameter analysis by means of more realistic geometry and material models.

From the designer's point of view, a design that invokes a substantial solution difference due to the volumetric effect of part geometry is not a desirable one, in terms of the controllability over the connection accuracy. Nonetheless, there always exists the difference between the lumped parameter model and reality, and this should be checked whenever necessary either through experiments or finite element analysis for selected particular cases.

Shown in FIG. 6.14 is a finite element contact simulation model built for this design using ABAQUS software. Sets of modified teeth are arranged along the tooth circle on the circular lower body, and the mating teeth of groove surfaces are fixed on the invisible upper body with the same arrangement. This model allows three degrees of relative freedom by having the lower body fixed in space and the upper body's two off-axis rotations constrained. During the contact simulation, the upper body finds its path to maintain the equilibrium among the local of contact forces as it is driven downward by the axial displacement boundary condition.

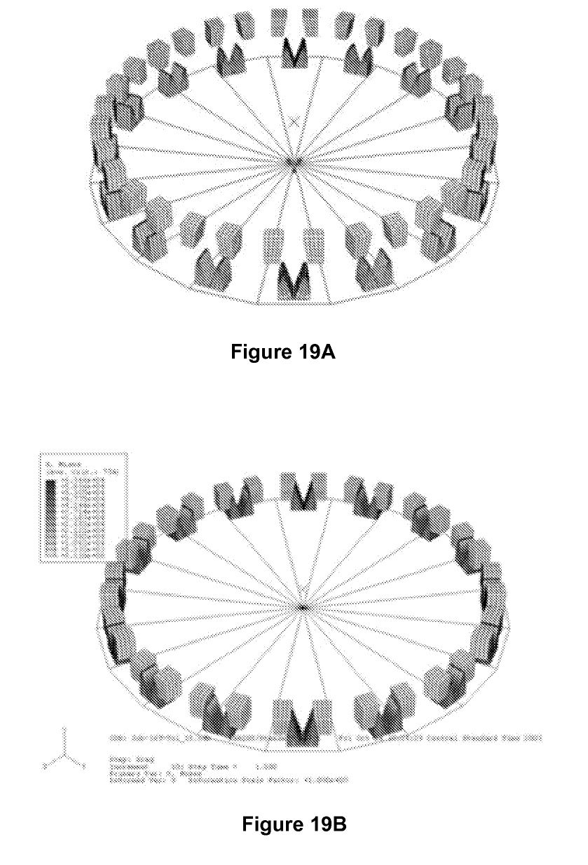

FIGS. 19A and 19B depict FEM contact simulation models.

As mentioned earlier, the purpose of this FEM analysis is to measure the level of agreement between the two different solution methods for the current design problem. For clear comparisons, analyses are performed with fairly simple sets of particular geometric errors for different connections having 4, 8, and 16 local contact sets. The specified geometric errors are introduced to the model through the adjustment of the individual teeth positions. The tooth arrangement and tooth numbering used in this analysis is illustrated in FIGS. 19A and 19B. The prepared error sets and the corresponding solution results from the two methods are discussed next.

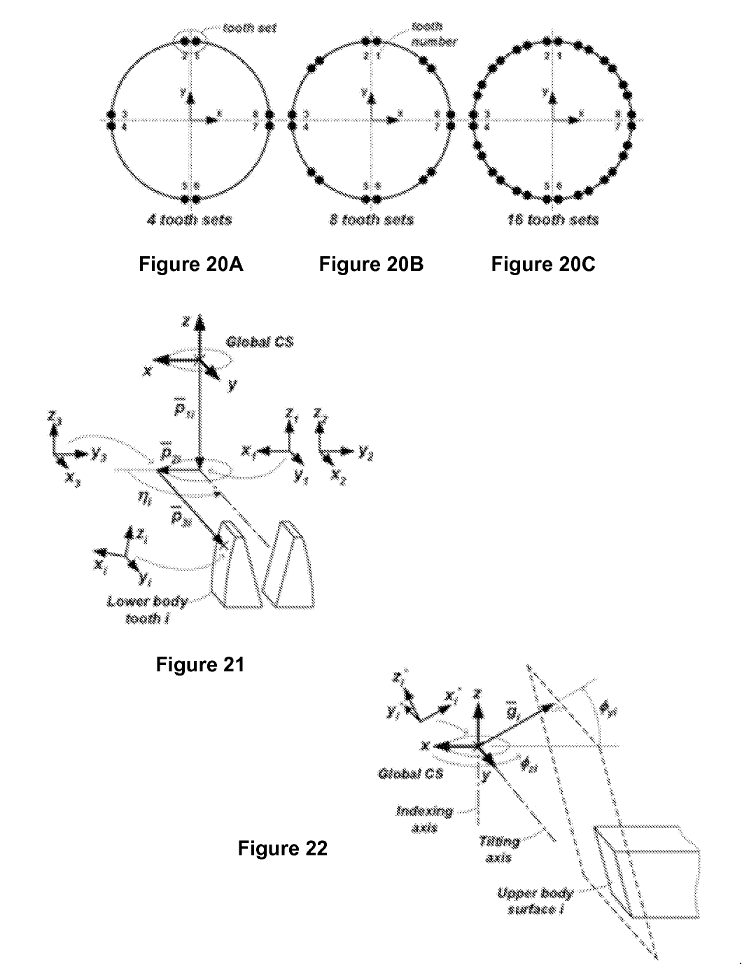

FIGS. 20A-20C depict contact teeth arrangement and numbering.

A. Lower Body Spring Position Errors

The lower body teeth positions are defined using a vector chain, reflecting the circular arrangement of the teeth and the resulting need for indexing operations in manufacturing (FIG. 6.16). The vector chain consists of three vectors passing through four intermediate coordinate frames to reach the initial position of the virtual contact spring. Each of three component vectors is associated with the lower body teeth positioning errors, which are; circumferential position error, axial position error, and radial position error.

The axial positioning error, δp₁, and the offset error, δp₂, come from the vertical and horizontal positioning of cutting tools, respectively. The circumferential positioning error is due to the indexing error, since the part will be indexed from cutting one tooth set to another. The radial error can come from turning operation to form the tooth blanks having inner and outer radii. However, this error has no effect on the connection accuracy because of the axis-symmetry in the resulting variation of the entire teeth. Here, the independent radial position changes for selected teeth are introduced to see the effect.

FIG. 21 depicts lower body tooth vector chain.

The analysis results for selected errors are listed in Table 6.15. To be on the conservative side, the linear tolerance values were selected from the worst tolerance grade applicable to the given process method. For angular tolerances, the accuracy values of the commercially available general-purpose indexing and tilting devices were applied.

The results from different calculation methods are generally close to one another. In Cases 11 and 12, for example, the differences between the three non-zero solutions in x- and y-directions are within 6% of the overall position changes for up to 8 tooth sets. The difference increases to within 20% for the same cases when 20 tooth sets are employed. These differences are contributed by the friction effect, the volumetric effect of misalignment, and the accuracy of FEM model and solutions.

In Case 13, all the errors were approximated as zero by the contact spring method, whereas FEM yielded errors of substantial magnitude in the x-direction. The introduced errors in this case is different from those of Case 11 and Case 12 because they induce a purely geometrical change of the connected system without directly changing the preload conditions of the local springs; they offset the local springs in the direction perpendicular to their orientation. This disturbs the moment balance of the connected system and causes it to rotate, which then affects the local preload conditions.

TABLE 6.15
Particular error analysis result (lower body)

| | | Case | | | | |
|---|---|---|---|---|---|---|
| | | 11 | 12 | 13 | 14 | 15 |
| Operation | | Surface | Surface grinding | Turning | Indexing | Combined |
| | | grinding | | | | |
| Tolerance grade | | IT8 | IT8 | IT13 | 40 sec | |
| | | | | | accuracy | |
| Nominal | | Tooth length | Tooth set | 2.2″ | 90 degrees | |
| Dimension | | 0.3″ | thickness 0.3″ | | | |
| Tolerance sets | | δp₁₁ = 0.00045 | δp₂₃ = 0.00045 | δp₃₂ = 0.018 | δη₄ = 20 sec | δp₁₁, δp₂₃, |
| | | δp₁₆ = 0.00045 | δp₂₈ = −0.00045 | δp35 = −0.018 | δη7 = 20 sec | δp32, δη4 |
| 4 Teeth sets | FEM | δx = 3.777e−5 | δx = 0 | δx = 1.261e−5 | δx = 6.020e−9 | δx = 2.483e−5 |
| | (μ = 0.16) | δy = 0 | δy = −2.250e−4 | δy = −3.424e−7 | δy = 1.337e−6 | δy = −1.648e−4 |
| | | δθ = 0 | δθ = 0 | δθ = 4.072e−7 | δθ = 2.425e−5 | δθ = 3.207e−5 |
| | FEM | δx = 3.864e−5 | δx = 0 | δx = 1.248e−5 | δx = 6.087e−9 | δx = 2.517e−5 |
| | (No | δy = 0 | δy = −2.250e−4 | δy = −9.240e−9 | δy = −1.013e−8 | δy = −1.660e−4 |
| | friction) | δθ = 0 | δθ = 0 | δθ = 4.079e−7 | δθ = 2.425e−5 | δθ = 3.212e−5 |
| | CSM | δx = 3.754e−6 | δx = 0 | δx = 0 | δx = 0 | δx = 1.984e−5 |
| | | δy = 0 | δy = −2.250e−4 | δy = 0 | δy = 0 | δy = −1.658e−4 |
| | | δθ = 0 | δθ = 0 | δθ = 0 | δθ = 2.424e−5 | δθ = 3.318e−5 |
| 8 Teeth sets | FEM | δx = 1.878e−5 | δx = 0 | δx = 6.385e−6 | δx = 2.724e−9 | δx = 1.250e−5 |
| | (μ = 0.16) | δy = 0 | δy = −1.125e−4 | δy = −1.724e−7 | δy = 7.222e−7 | δy = −8.228e−5 |
| | | δθ = 0 | δθ = 0 | δθ = 2.055e−7 | δθ = 1.212e−5 | δθ = 1.602e−5 |
| | FEM | δx = 1.930e−5 | δx = 0 | δx = 6.321e−6 | δx = 2.836e−9 | δx = 1.271e−5 |
| | (No friction) | δy = 0 | δy = −1.126e−4 | δy = −5.106e−9 | δy = 2.409e−8 | δy = −8.296e−5 |
| | | δθ = 0 | δθ = 0 | δθ = 2.059e−7 | δθ = 1.212e−5 | δθ = 1.604e−5 |
| | CSM | δx = 1.984e−5 | δx = 0 | δx = 0 | δx = 0 | δx = 9.918e−6 |
| | | δy = 0 | δy = −1.125e−4 | δy = 0 | δy = 0 | δy = −8.291e−5 |
| | | δθ = 0 | δθ = 0 | δθ = 0 | δθ = 1.212e−5 | δθ = 1.659e−5 |
| 16 Teeth sets | FEM | δx = 9.468e−6 | δx = 0 | δx = 1.643e−6 | δx = 7.643e−10 | δx = 5.530e−6 |
| | (μ = 0.16) | δy = 0 | δy = −4.702e−5 | δy = −6.725e−8 | δy = −5.985e−7 | δy = −3.683e−5 |
| | | δθ = 0 | δθ = 0 | δθ = 8.860e−8 | δθ = 5.939e−6 | δθ = 7.174e−6 |
| | FEM | δx = 9.570e−6 | δx = 0 | δx = 1.687e−6 | δx = 1.082e−9 | δx = 5.595e−6 |
| | (No friction) | δy = 0 | δy = −4.737e−5 | δy = −3.061e−9 | δy = −4.027e−7 | δy = −3.712e−5 |
| | | δθ = 0 | δθ = 0 | δθ = 8.817e−8 | δθ = 5.964e−6 | δθ = 7.201e−6 |
| | CSM | δx = 9.918e−6 | δx = 0 | δx = 0 | δx = 0 | δx = 4.959e−6 |
| | | δy = 0 | δy = −5.625e−5 | δy = 0 | δy = 0 | δy = −4.146e−5 |
| | | δθ = 0 | δθ = 0 | δθ = 0 | δθ = 6.060e−6 | δθ = 8.295e−6 |

The reason why this change is not accounted for by the contact spring method is because those higher order terms associated with this indirect effect of spring position change have been dropped through the linearization process. This only means that the connection state is normally much more sensitive on the geometry variations that directly compress or release the springs than on those that do not. Choosing from the worst tolerance grade applicable, the magnitude of the introduced tolerance for Case 13 happened to be two orders of magnitude greater than those of other cases, and the FEM was able to pick up this geometrically nonlinear change through iterations, whereas the CSM was not.

B. Upper Body Surface Position Errors

The flat contact surfaces may belong to either grooves or external teeth. Grooves are simpler to generate than external teeth and suitable for applications where the thickness of the repeated sets is not necessarily equal to the pitch distance between teeth. The grooves provide good control over the contact locations but they do not provide the bending compliance that the external teeth do. The main reason this design employs grooves on one body is to provide the separate large area contact surfaces for strong structural support. The upper body coordinate frames are shown in FIG. 6.17.

FIG. 22 depicts upper body geometry parameters.

Three variation parameters are the two angles, φ_{zi} and φ_{yi}, for surface normal direction, and the distance g. Error in angle φ_{zi} comes from indexing operation for the same reason as the lower body. The error in φ_{yi} has to do with tilting error. The origin must be located at the point of intersection between the axis of tilting and the axis of indexing. The g is the error from tool positioning in the direction perpendicular to the surface.

TABLE 6.16
Particular error analysis result (upper body)

| | | Case | | | |
|---|---|---|---|---|---|
| | | 21 | 22 | 23 | 24 |
| Operation | | Surface | Tilting | Indexing | Combined |
| | | grinding | | | |
| Tolerance grade | | IT8 | 60 sec accuracy | 40 sec accuracy | |
| Nominal Dimension | | 0.5″ | 20 degrees | 90 degrees | |
| Tolerance sets | | δg₁ = −0.0005 | δφ₂₃ = 30 sec | δφ₃₂ = 20 sec | δg₁, δφ₂₃, |
| | | δg₆ = −0.0005 | δφ₂₈ = 30 sec | δφ₃₅ = 20 sec | δφ₃₂, δη4 |
| 4 Teeth | FEM | δx = 2.473e−4 | δx = 0 | δx = 1.377e−6 | δx = 1.766e−4 |
| sets | (μ= 0.16) | δy = 0 | δy = 2.076e−4 | δy = −7.767e−8 | δy = 1.036e−4 |
| | | δθ = 0 | δθ = 0 | δθ = −2.425e−5 | δθ = −6.508e−5 |
| FEM | | δx = 2.539e−4 | δx = 0 | δx = 3.314e−8 | δx = 1.803e−4 |
| (No friction) | | δy = 0 | δy = 2.131e−4 | δy = −7.912e−8 | δy = 1.065e−4 |
| | | δθ = 0 | δθ = 0 | δθ = −2.425e−5 | δθ = −6.508e−5 |
| CSM | | δx = 2.539e−4 | δx = 0 | δx = 0 | δx = 1.802e−4 |
| | | δy = 0 | δy = 2.129e−4 | δy = 0 | δy = 1.065e−4 |
| | | δθ = 0 | δθ = 0 | δθ = −2.424e−5 | δθ = −6.527e−5 |
| 8 Teeth | FEM | δx = 1.234e−4 | δx = 0 | δx = 7.230e−7 | δx = 8.824e−5 |
| sets | (μ= 0.16) | δy = 0 | δy = 1.036e−4 | δy = −1.829e−8 | δy = 5.175e−5 |
| | | δθ= 0 | δθ = 0 | δθ = −1.212e−5 | δθ = −3.252e−5 |
| FEM | | δx = 1.268e−4 | δx = 0 | δx = 2.491e−8 | δx = 9.009e−5 |
| (No friction) | | δy = 0 | δy = 1.065e−4 | δy = −1.876e−8 | δθ = 5.325e−5 |
| | | δθ = 0 | δθ = 0 | δθ = −1.212e−5 | δθ = −3.252e−5 |
| CSM | | δx = 1.269e−4 | δx = 0 | δx = 0 | δx = 9.008e−5 |
| | | δy = 0 | δy = 1.065e−4 | δy = 0 | δy = 5.323e−5 |
| | | δθ = 0 | δθ = 0 | δθ = −1.212e−5 | δθ = −3.263e−5 |
| 16 Teeth | FEM | δx = 6.296e−5 | δx = 0 | δx = −5.982e−7 | δx = 4.468e−5 |
| sets | (μ= 0.16) | δy = 0 | δy = 5.335e−5 | δy = −7.266e−9 | δy = 2.666e−5 |
| | | δθ = 0 | δθ = 0 | δθ = −5.939e−6 | δθ = −1.631e−5 |

| | | | | |
|---|---|---|---|---|
| FEM | δx = 6.337e−5 | δx = 0 | δx = −4.024e−7 | δx = 4.503e−5 |
| (No friction) | δy = 0 | δy = 5.370e−5 | δy = −6.850e−9 | δy = 2.685e−5 |
| | δθ = 0 | δθ = 0 | δθ = −5.964e−6 | δθ = −1.631e−5 |
| CSM | δx = 6.346e−5 | δx = 0 | δx = 0 | δx = 4.504e−5 |
| | δy = 0 | δy = 5.323e−5 | δy = 0 | δy = 2.662e−5 |
| | δθ = 0 | δθ = 0 | δθ = −6.060e−6 | δθ = −1.632e−5 |

The analysis result is listed in Table 6.16. The same level of tolerances applied to the lower body is employed for surface grinding and indexing. Tilting accuracy is generally not as good as indexing accuracy. The 60 arc second angular accuracy of a commercially available general-purpose tilting table is used. It is assumed that the distance from the axis of tilting to the top of the clamped part is 3 inches.

With the coordinate systems distributed to all the local contact locations as described above, the linearized three-dimensional compatibility equation is
qᵢ=−xᵤCφ_{iy}Cφ_{iz}−yᵤCφ_{iy}Sφ_{iz}+zᵤSφ_{iy}+θᵤₓ(p₁ᵢCφ_{iy}Sφ_{iz}+p₂ᵢCηᵢSφ_{iy}+p₃ᵢSηᵢSφ_{iy})−θ_{uy}(p₁ᵢCφ_{iy}Cφ_{iz}−p₂ᵢSηᵢSφ_{iy}+p₃ᵢCηᵢSφ_{iy})+θ_{uz}[p₂ᵢ(SηᵢCφ_{iy}Sφ_{iz}+CηᵢCφ_{iy}Cφ_{iz})−p₃ᵢ(CηᵢCφ_{iy}Sφ_{iz}−SηᵢCφ_{iy}Cφ_{iz})]−p₁ᵢSφ_{iy}+p₂ᵢ(−SηᵢCφ_{iy}Cφ_{iz}+CηᵢCφ_{iy}Sφ_{iz})+p₃ᵢ(CηᵢCφ_{iy}Cφ_{iz}+SηᵢCφ_{iy}Sφ_{iz})−gₓ
whose constant terms in the last line constitute the local preload state, bᵢ.

The geometry modeling though the contact spring formulation yields the [6×6] interface stiffness matrix, K_{sys}, which is

$${\tilde{K}}_{sys} = \frac{N}{4} \cdot [ \begin{matrix}9.16 \times {10}^{5} & 0 & 0 & 0 & - 2.68 \times {10}^{6} & 0 \\ 0 & 9.16 \times {10}^{5} & 0 & 2.68 \times {10}^{6} & 0 & 0 \\ 0 & 0 & 5.69 \times {10}^{4} & 0 & 0 & 0 \\ 0 & 2.68 \times {10}^{6} & 0 & 7.99 \times {10}^{6} & 0 & 0 \\ - 2.68 \times {10}^{6} & 0 & 0 & 0 & 7.99 \times {10}^{6} & 0 \\ 0 & 0 & 0 & 0 & 0 & 8.83 \times {10}^{6}\end{matrix} ]$$

where N is the total number of local tooth sets of each coupling body. This is the connection stiffness obtained purely from the alignment system, and the external sealing contact is yet to provide significant stiffness augmentation, especially in bending direction. The translation and torsional stiffness values with 4 tooth sets are 9.16×10⁵ lbf/in and 1.28×10⁴ ft-lbf/deg, respectively, which already satisfy the corresponding stiffness requirements specified in Table 6.3. This means the tooth design is valid for all three cases of the tooth set numbers in the context of stiffness.

The solution results of the 4 tooth set cases and the 16 tooth set cases are plotted for contrast in FIGS. 6.18. The plots of the same displacement variables have been scaled to have the same profiles. Here, the dotted lines plot the FEM results both with and without friction effect. Even though it is observed in many cases that the friction effect brings the FEM results closer to the solutions from contact spring method, the differences between the friction and no friction cases are so small that it is not noticeable in these plots.

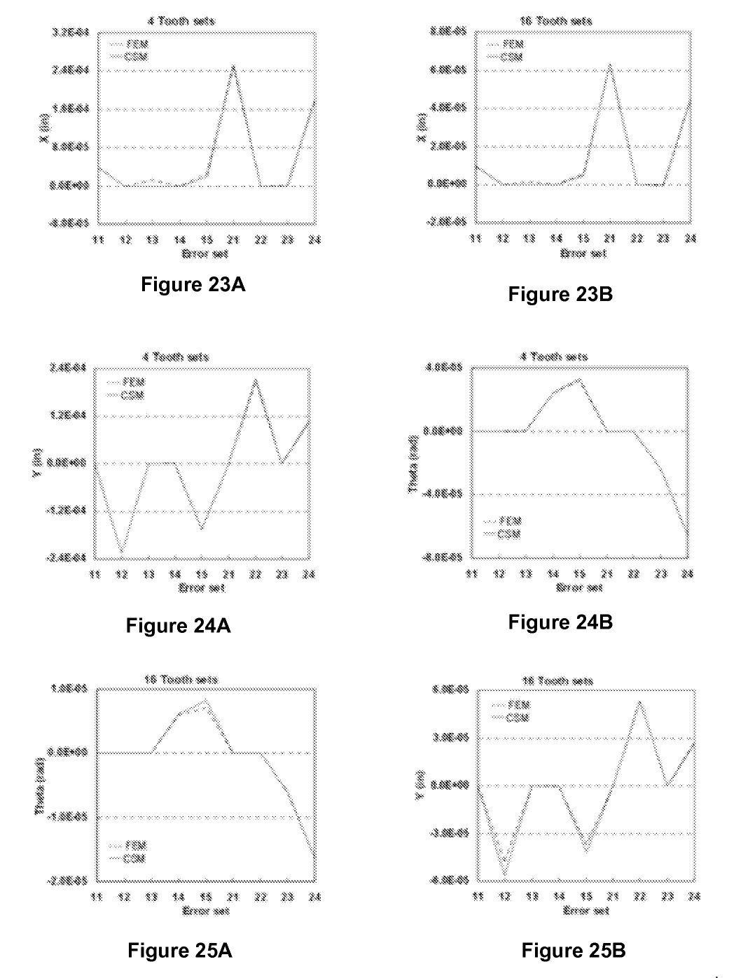

FIGS. 23A and 23B depict FEM and CSM results comparison plots (x).

[image]

FIGS. 24A and 24B depict FEM and CSM results comparison plots (y). FIGS. 24A and 24B depict FEM and CSM results comparison plots (θ).

As can be seen from the plots, the overall level of accordance among the three different solutions is very high, and it is higher with a lower number of contact teeth. Clear discrepancies are observed at some of the large displacement points. The effect of the purely geometric spring offset, which was clearly seen in the x-direction of Case 13 with 4 tooth sets, becomes less outstanding with mixed tolerances in Case 15 and also with increased tooth sets.

The maximum solution differences observed in this analysis were 1.26×10⁻⁵ in and 1.12×10⁻⁶ rad, which are 5.1% and 6.9% of the maximum linear and angular displacements occurred, respectively. Such percentages, obtained after a good number of particular error analyses, can give a good measure of feasibility in using CSM as an accuracy analysis tool for the given design. The maximum difference to maximum displacement ratios of less than 10% should be in the acceptable range in general, especially considering that CSM mostly yields conservative solutions in terms of accuracy.

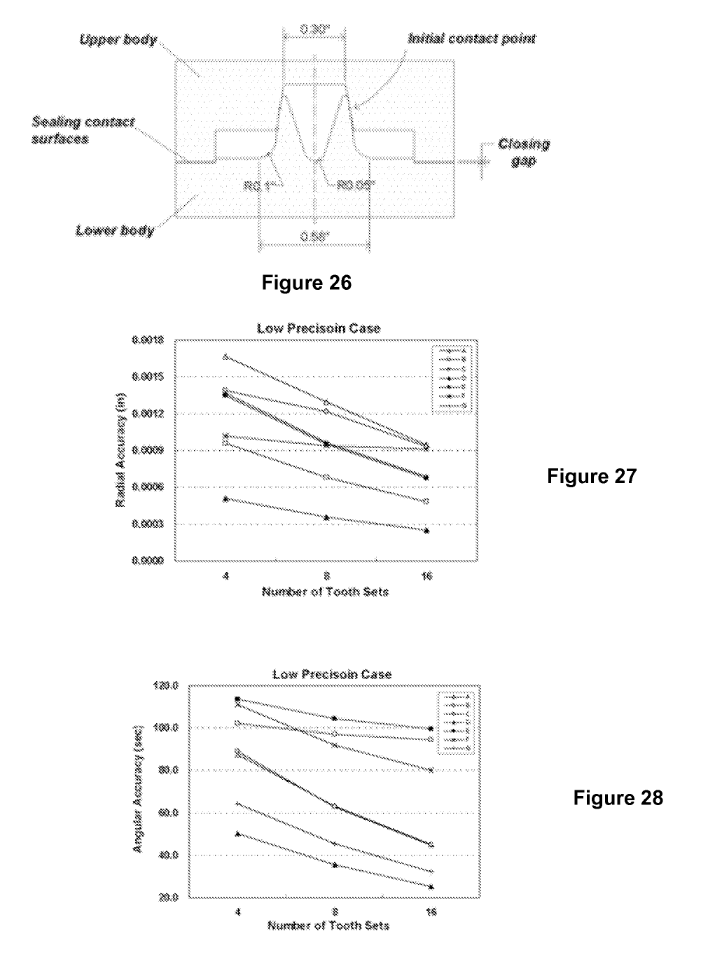

With the modified beam, the 30 ksi reduction in maximum stress automatically allows for 23% margin of safety for steel 4340. Maintaining the previous contact location of 0.005″ below the initial contact point yields the local initial contact configuration shown in FIG. 6.19. To the left and right of the tooth set are the closing gaps for the external large-area flat contacts. The roles of the external flat contacts are to control the clamping distance, decouple the vertical degree of freedom from all the error motions due to tolerance, and provide stiff bending support for the work loads. FIG. 26 depicts a final local contact geometry.

III. Accuracy Analysis

With the local contact geometry fully established, we can proceed to the accuracy analysis and then to the detail design on the overall coupling bodies and clamping parts. The accuracy analysis first requires the establishment of the manufacturing procedure for the coupling interface. In this design, it is planned that the designed interface will be manufactured in the following procedure.

1) Overall Geometry Cutting

From the raw material, the axis-symmetric geometry of overall height and diameter is cut in a turning process. Next, the tooth blank is cut from the top surface down to the tooth base surface with given inside and outside diameters. The tooth base surface is positioned with reference to the bottom of the part. Achievement of good flatness, roundness, perpendicularity and parallelism among the outmost surfaces is critical for the processes to follow.

2) Sealing Contact Surface Generation

The sealing flat contact surfaces of both bodies must be located with the highest level of precision. For the upper body, this is the far out surface that defines the overall height of the part. For the lower body, a division of the tooth base surface is lowered to form its shouldered flat contact surface. These surfaces must be precision ground for high position accuracy, flatness, and also the perpendicularity with the part axis.

3) Basic Tooth Geometry Cutting

Coarse triangular teeth are cut from the tooth blank on a horizontal milling machine in conjunction with part indexing operations. The two outside contact surfaces and inside surfaces of a tooth set are cut in series with vertical part feeding after horizontal tool positioning. After completing a single tooth set, the part is indexed to the next tooth set. The groove surfaces of the upper body are also cut in the same manner.

4) Tooth Surface Finishing

The operations performed in this step are basically the same as that of step 3. The main difference is the raised precision level by employing a grinding machine instead of a milling machine. Accurate tool positioning and part indexing processes in this step are critical for the resulting connection accuracy. Depending on the preference, one can choose the sequence of operations among many possible options. For the current interface geometry, seven procedures of different grinding sequences, A through G of the following, are considered for the accuracy analysis. The procedures apply to both the upper body and the lower body.

Procedure A:

Right surface grinding of a tooth set→Left side surface grinding of a tooth set→Part indexing to the next tooth set→Left side surface grinding of a tooth set→Right surface grinding of a tooth set→Repeat the process for one full part rotation.

Procedure B:

Right surface grinding of a tooth set→Part indexing to the next tooth set→Repeat the process for one full part rotation→Left side surface grinding of a tooth set→Part indexing to the next tooth set→Repeat the process for another full part rotation

Procedure C:

Right surface grinding of two diametrically opposite tooth sets→Left surface grinding of two diametrically opposite tooth sets→Part indexing to the next tooth sets→Left surface grinding of two diametrically opposite tooth sets→Right surface grinding of two diametrically opposite tooth sets→Repeat the process for half part rotation.

Procedure D:

Right surface grinding of two diametrically opposite tooth sets→Part indexing to the next tooth sets→Repeat the process for one full part rotation.

Procedure E:

Simultaneous left and right surface grinding of a tooth set→Part indexing to the next tooth set→Repeat the process for one full part rotation.

Procedure F:

Simultaneous left and right surface grinding of two diametrically opposite tooth sets→Part indexing to the next tooth sets→Repeat the process for half part rotation.

Procedure G:

Right surface grinding of a tooth set→Part indexing to the next tooth set→Left side surface grinding of a tooth set→Part indexing to the next tooth set→Repeat the process for two full part rotations.

The last procedure is probably the most inefficient way of finishing the interface due to its excessive number of positioning operations. However, this procedure is kept as a reference case, since it allows each of the positioning errors associated with the tooth surfaces to be independent of the others. It is assumed that the grinding wheel being used has both sides available for finishing.

Just as in the particular error analysis previously performed, the statistical accuracy analysis is also performed with 4, 8, and 16 local tooth sets for two different levels of manufacturing precision. Since the teeth and groove surfaces will be finish ground to their final shapes, selection of two extreme precision levels of common grinding operations will be reasonable to observe the resulting range of connection accuracy. According to the ANSI tolerance table [34], tolerances for grinding range from grade 5 to grade 8. Tables 6.17 and 6.18 show the application of the tolerances of the two extreme grades to the major variation parameters of the two coupling bodies.

TABLE 6.17
Lower body tolerances

| | | Nominal | | Tolerance | | | |
|---|---|---|---|---|---|---|---|
| Parameter | Error | Dimension | | grade | Tolerance | | Variance |
| Tooth contact | Horizontal | 0˜0.1 | in | ANSI 5 | 0.00015 | in | 0.039 |
| surface | tool | | | ANSI 8 | 0.0006 | in | |
| | positioning | 0.6 | in | ANSI 5 | 0.0003 | in | |
| | | | | ANSI 8 | 0.001 | in | |
| Tooth contact | Vertical tool | 0.3 | in | ANSI 5 | 0.00025 | in | 0.039 |
| surface | positioning | | | ANSI 8 | 0.0009 | in | |
| Tooth set position | Part | 22.5 | deg | CURVIC | 10 | sec | 0.034 |
| | indexing | | | Accuracy | | | |
| | | | | General | 80 | sec | |
| | | | | Accuracy | | | |
| Sealing contact | Vertical tool | 1.24 | in | ANSI 5 | 0.0004 | in | 0.039 |
| surface | positioning | | | ANSI 8 | 0.0016 | in | |

TABLE 6.18
Upper body tolerances

| | | Nominal | | Tolerance | | | |
|---|---|---|---|---|---|---|---|
| Parameter | Error | Dimension | | grade | Tolerance | | Variance |
| Groove contact | Horizontal | 0˜0.1 | in | ANSI 5 | 0.00015 | in | 0.039 |
| surface | tool | | | ANSI 8 | 0.0006 | in | |
| | positioning | | | | | | |
| Groove contact | Vertical tool | 0.25 | in | ANSI 5 | 0.00025 | in | 0.039 |
| surface | positioning | | | ANSI 8 | 0.0009 | in | |
| Groove position | Part | 22.5 | deg | CURVIC | 10 | sec | 0.034 |
| | indexing | | | Accuracy | | | |
| | | | | General | 80 | sec | |
| | | | | Accuracy | | | |
| Sealing contact | Vertical tool | 1.54 | in | ANSI 5 | 0.0004 | in | 0.039 |
| surface | positioning | | | ANSI 8 | 0.0016 | in | |

For the indexing angle tolerances, the commonly known accuracy of manual indexing tables and that of the Curvic indexing devices, ±40 arc sec and ±5 arc sec, respectively, are applied for low and high precision levels. The variance data are obtained from the statistics table for common machining operations, from Bjorke [4]. The decoupled axial connection accuracy is independently obtained using the tolerances for the closing contact surfaces.

According to the manufacturing procedure described above, the indexing error induces the circumferential position variation of the teeth and groove surfaces, the horizontal tool position error induces their tangential position variations, and the vertical grinding wheel position affects their axial position variations. The effect of radial positioning error in turning operations cancels out due to the axis-symmetry in the constrained variation of the entire teeth.

As discussed in the previous chapter, the dimension parameters of the formulation must be properly linked depending on the manufacturing procedure selected, in order for the introduced tolerance and variance data to take their correct influences on the connection accuracy. Generation of all the necessary sub-parameters through the parameter decomposition is in order for later merging of some of those parameters if necessary.

To take care of the vertical and horizontal tool positioning errors, the upper body parameter g_{\vec{σ}} that defines the distance to the contact surfaces must be decomposed into two independent parameters, each for one of the perpendicular directions. Since the generated sub-parameters differ from the original one, the conversion factors must be provided with the tolerance input. Decomposing the original vector into two component vectors pointing in the same direction,
δ\vec{g}ᵢ=δ\vec{g}1ᵢ+δ\vec{g}2ᵢ

from which the horizontal and vertical position variation parameters

$$δ g {1}_{i} ≡ \frac{\vert δ {g}^{->} {1}_{i} \vert}{cos {ϕ}_{i}} and δ g {2}_{i} ≡ \frac{\vert δ {g}^{->} {2}_{i} \vert}{sin {ϕ}_{i}}$$

are defined, respectively, using the direction cosines. Note that this g vector decomposition is an example of handling the directional discrepancy problem between the formulation parameters and applied tolerances. \vec{σ}

Further parameter decomposition is possible depending on the knowledge on other possible independent error sources. The errors associated with the initial relative position between the tool and the part, for example, can be handled by performing the final decomposition of all the parameters. The newly added parameters of all the teeth are then merged together since the calibration errors affect the entire interface. Those initial position errors are mostly measurement errors and assumed to be ignorable in this analysis.

The parameter merging is now performed according to the seven procedures discussed above. The lower body parameter merging is briefly demonstrated in Table 6.19 for the interface having four tooth sets. Notice that each procedure has unique combination of linked conditions for the indexing error and the horizontal tool positioning error, δ η and δ p2. The same merging rules apply to the cases of more tooth sets, and also to the tolerance parameters, δ φ_{z} and δ g1, of the upper body except for some sign changes due to the orientation differences in the base coordinate systems.

TABLE 6.19
Parameter merging for lower body with 4 tooth sets

| | Merged | | |
|---|---|---|---|
| Proce- | param- | Linked | |
| dure | eters | pattern | Relations |
| A | δηᵢ | 1-2, 3-4, | δη₁ = δη₂, δη₃ = δη₄, |
| | | 5-6, 7-8 | δη₅ = δη₆, δη₇ = δη₈ |
| | δp2ᵢ | 2-4, 3-5, | δp2₂ = δp2₄, δp2₃ = δp2₅, |
| | | 6-8 | δp2₆ = δp2₈ |
| B | δp2ᵢ | 1-3-5-7, | δp2₁ = δp2₃ = δp2₅ = δp2₇, |
| | | 2-4-6-8 | δp2₂ = δp2₄ = δp2₆ = δp2₈ |
| C | δηᵢ | 1-2-5-6, | δη₁ = δη₂ = δη₅ = δη₆, |
| | | 3-4-7-8 | δη₃ = δη₄ = δη₇ = δη₈ |
| | δp2ᵢ | 1-6, 3-8, | δp2₁ = −δp2₆, δp2₃ = −δp2₈, |
| | | 2-4-5-7 | δp2₂ = δp2₄ = −δp2₅ = −δp2₇ |
| D | δηᵢ | 1-6, 2-5, | δη₁ = δη₆, δη₂ = δη₅, |
| | | 3-8, 4-7 | δη₃ = δη₈, δη₄ = δη₇ |
| | δp2ᵢ | 1-2-3-4-5-6-7-8 | δp2₁ = −δp2₂ = δp2₃ = −δp2₄ = |
| | | | δp2₅ = −δp2₆ = δp2₇ = −δp2₈ |
| E | δηᵢ | 1-2, 3-4, | δη₁ = δη₂, δη₃ = δη₄, |
| | | 5-6, 7-8 | δη₅ = δη₆, δη₇ = δη₈ |
| | δp2ᵢ | 1-2-3-4-5-6-7-8 | δp2₁ = δp2₂ = δp2₃ = δp2₄ = |
| | | | δp2₅ = δp2₆ = δp2₇ = δp2₈ |
| F | δηᵢ | 1-2-5-6, | δη₁ = δη₂ = δη₅ = δη₆, |
| | | 3-4-7-8 | δη₃ = δη₄ = δη₇ = δη₈ |
| | δp2ᵢ | 1-2-3-4-5-6-7-8 | δp2₁ = δp2₂ = δp2₃ = δp2₄ = |
| | | | −δp2₅ = −δp2₆ = −δp2₇ = −δp2₈ |
| G | None | None | None |

Table 6.20 shows the accuracy analysis results for the five finishing procedures. Each procedure is analyzed with both high and low precision levels corresponding to the two tolerance grades that appear in Tables 6.17 and 6.18. The horizontal position accuracy is represented by the radial magnitude, which is
δr=√δx²+δy²

The maximum error range values are based on Equation (5.7), which does not take the probability distribution of the total errors into consideration.

TABLE 6.20
Accuracy calculation results

| | Precision | Tooth | Maximum range | | 6σ accuracy | |
|---|---|---|---|---|---|---|
| | level | sets | δr | δθ | δr | Δθ |
| Procedure A | Low | 4 | 5.12 × 10⁻³ in | 340.3 sec | 1.67 × 10⁻³ in | 87.7 sec |
| | | 8 | 6.18 × 10⁻³ in | 340.3 sec | 1.30 × 10⁻³ in | 63.1 sec |
| | | 16 | 6.43 × 10⁻³ in | 340.3 sec | 9.48 × 10⁻⁴ in | 45.0 sec |
| | High | 4 | 1.06 × 10⁻³ in | 70.5 sec | 3.31 × 10⁻⁴ in | 19.3 sec |
| | | 8 | 1.28 × 10⁻³ in | 70.5 sec | 2.81 × 10⁻⁴ in | 14.0 sec |
| | | 16 | 1.34 × 10⁻³ in | 70.5 sec | 2.11 × 10⁻⁴ in | 10.1 sec |
| Procedure B | Low | 4 | 2.86 × 10⁻³ in | 340.3 sec | 9.62 × 10⁻⁴ in | 102.3 sec |
| | | 8 | 3.45 × 10⁻³ in | 340.3 sec | 6.80 × 10⁻⁴ in | 97.2 sec |
| | | 16 | 3.59 × 10⁻³ in | 340.3 sec | 4.81 × 10⁻⁴ in | 94.5 sec |
| | High | 4 | 4.26 × 10⁻⁴ in | 70.5 sec | 1.29 × 10⁻⁴ in | 27.0 sec |
| | | 8 | 5.15 × 10⁻⁴ in | 70.5 sec | 9.11 × 10⁻⁵ in | 26.8 sec |
| | | 16 | 5.35 × 10⁻⁴ in | 70.5 sec | 6.45 × 10⁻⁵ in | 26.6 sec |
| Procedure C | Low | 4 | 2.72 × 10⁻³ in | 189.8 sec | 1.39 × 10⁻³ in | 88.9 sec |
| | | 8 | 3.27 × 10⁻³ in | 189.8 sec | 1.22 × 10⁻³ in | 62.9 sec |
| | | 16 | 3.41 × 10⁻³ in | 189.8 sec | 9.34 × 10⁻⁴ in | 44.6 sec |
| | High | 4 | 7.61 × 10⁻⁴ in | 28.3 sec | 4.02 × 10⁻⁴ in | 11.3 sec |
| | | 8 | 9.19 × 10⁻⁴ in | 28.3 sec | 3.50 × 10⁻⁴ in | 8.0 sec |
| | | 16 | 9.57 × 10⁻⁴ in | 28.3 sec | 2.69 × 10⁻⁴ in | 5.7 sec |
| Procedure D | Low | 4 | 1.05 × 10⁻³ in | 149.7 sec | 5.08 × 10⁻⁴ in | 50.3 sec |
| | | 8 | 1.27 × 10⁻³ in | 149.7 sec | 3.59 × 10⁻⁴ in | 35.5 sec |
| | | 16 | 1.32 × 10⁻³ in | 149.7 sec | 2.53 × 10⁻⁴ in | 25.2 sec |
| | High | 4 | 1.99 × 10⁻⁴ in | 23.3 sec | 7.88 × 10⁻⁵ in | 6.7 sec |
| | | 8 | 2.42 × 10⁻⁴ in | 23.3 sec | 5.57 × 10⁻⁵ in | 4.7 sec |
| | | 16 | 2.52 × 10⁻⁴ in | 23.3 sec | 3.93 × 10⁻⁵ in | 3.3 sec |

TABLE 6.20
Accuracy calculation results (continued)

| | Precision | Tooth | Maximum range | | 6σ accuracy | |
|---|---|---|---|---|---|---|
| | level | sets | δr | δθ | δr | δθ |
| Procedure E | Low | 4 | 2.86 × 10⁻³ in | 303.2 sec | 1.35 × 10⁻³ in | 113.7 sec |
| | | 8 | 3.45 × 10⁻³ in | 303.2 sec | 9.52 × 10⁻⁴ in | 104.6 sec |
| | | 16 | 3.59 × 10⁻³ in | 303.2 sec | 6.73 × 10⁻⁴ in | 99.6 sec |
| | High | 4 | 4.26 × 10⁻⁴ in | 56.5 sec | 1.74 × 10⁻⁴ in | 25.0 sec |
| | | 8 | 5.15 × 10⁻⁴ in | 56.5 sec | 1.23 × 10⁻⁴ in | 24.3 sec |
| | | 16 | 5.35 × 10⁻⁴ in | 56.5 sec | 8.73 × 10⁻⁵ in | 23.9 sec |
| Procedure F | Low | 4 | 1.30 × 10⁻³ in | 245.5 sec | 1.02 × 10⁻³ in | 111.2 sec |
| | | 8 | 1.30 × 10⁻³ in | 245.5 sec | 9.38 × 10⁻⁴ in | 91.8 sec |
| | | 16 | 1.27 × 10⁻³ in | 245.5 sec | 9.16 × 10⁻⁴ in | 80.2 sec |
| | High | 4 | 3.37 × 10⁻⁴ in | 42.5 sec | 2.57 × 10⁻⁵ in | 20.2 sec |
| | | 8 | 3.39 × 10⁻⁴ in | 42.5 sec | 2.35 × 10⁻⁴ in | 18.5 sec |
| | | 16 | 3.34 × 10⁻⁴ in | 42.5 sec | 2.29 × 10⁻⁴ in | 17.7 sec |
| Procedure G | Low | 4 | 5.12 × 10⁻³ in | 340.3 sec | 1.37 × 10⁻³ in | 64.4 sec |
| | | 8 | 6.18 × 10⁻³ in | 340.3 sec | 9.68 × 10⁻⁴ in | 45.6 sec |
| | | 16 | 6.43 × 10⁻³ in | 340.3 sec | 6.86 × 10⁻⁴ in | 32.2 sec |
| | High | 4 | 1.06 × 10⁻³ in | 70.5 sec | 3.10 × 10⁻⁴ in | 14.5 sec |
| | | 8 | 1.28 × 10⁻³ in | 70.5 sec | 2.19 × 10⁻⁴ in | 10.3 sec |
| | | 16 | 1.34 × 10⁻³ in | 70.5 sec | 1.54 × 10⁻⁴ in | 7.3 sec |

The maximum range for the radial error generally increases for the increasing number of contact teeth, whereas the radial accuracy consistently reduces for the same changes. This indicates centralization of the range of likelihood, otherwise called the error averaging effect. Among the obtained results, the radial and the angular accuracy values are compared in the following plots. Each plot shows the calculation results with varying number of tooth sets for the selected manufacturing precision level and the selected manufacturing procedure among those labeled A through G.

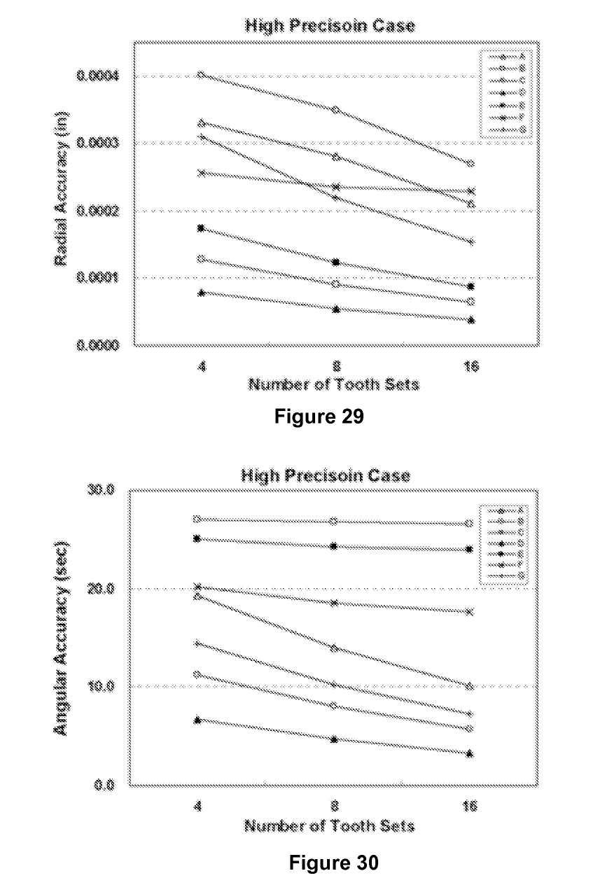

27 depicts precision radial accuracy plots. FIG. 28 depicts low precision angular accuracy plots. FIG. 29 depicts high precision radial accuracy plots. FIG. 30 depicts high precision angular accuracy plots.

From these plots, the followings observations are made about the analysis:

1) Different manufacturing procedures result in different accuracy levels for the same applied machining tolerances. Depending on the procedures, the obtainable accuracy with the low precision tolerance values can be close to, and even higher than the accuracy obtained with the high precision tolerances.

2) Use of more contact teeth enhances connection accuracy. Although exceptions exist due to other factors, taking the second power of the tooth number doubles the accuracy level.

3) Depending on the procedure selected, the obtained level of radial accuracy can be different from the level of angular accuracy for the same condition.

4) Smaller tool movements during manufacturing result in higher accuracy.

5) The highest position accuracy obtainable is 3.93×10⁻⁵ in from Procedure D, and the highest angular accuracy obtainable is 3.3 sec, also from Procedure D.

6) The lowest position accuracy obtained is 1.67×10⁻³ in from Procedure A, and the lowest angular accuracy obtained is 113.7 sec from Procedure E.

According to the result, the highest position 3σ accuracy achievable is on the order of 0.5 μm, which is about the best positioning accuracy that Curvic couplings are known to have achieved in the literature. The highest angular accuracy achievable is also comparable with the known angular repeatability of Curvic coupling. This is a highly desirable level of connection accuracy, considering the point that the repeatability of Curvic couplings is measured from the repeated coupling of a permanent pair, whereas the accuracy of the current design is based on random-pairing within a given set. Generally, in robotics area, it is considered that the system accuracy is an order of magnitude lower than the system repeatability.

Care must be provided when interpreting these results since the calculations are made using the selected machining errors, assuming that any other possible errors can be ignored. In Procedure D, for instance, the simultaneous cutting of two surfaces of the diametrically opposite tooth sets requires a relatively long feeding distance. For such a long travel distance, errors may also exist in the transverse direction accompanying the linear motion, depending on the precision of the machines used. This type of case-dependent errors, if their magnitude is substantial, should be included in the analysis. It is also noteworthy that, even though we have eliminated much of the connection uncertainty through the compliance-based alignment method that does not allow clearance gaps by its nature, there still is some amount of repeatability problem due to surface friction and surface degradations such as wear and pitting. One must anticipate that this may lower the overall connection accuracy level to some degree.

The design processes discussed so far covering up to the accuracy analysis step can be iterated with design modifications until the desirable level of connection accuracy is achieved. Once the iteration process is complete, the support structure needs to be designed with the emphasis on the connection stiffness. It has been stressed many times that the connection stiffness has a critical influence on the end-effecter errors in robot structures. The overall geometry of the two designed interface parts and their connected shape are shown in FIG. 6.24 and FIG. 6.25.

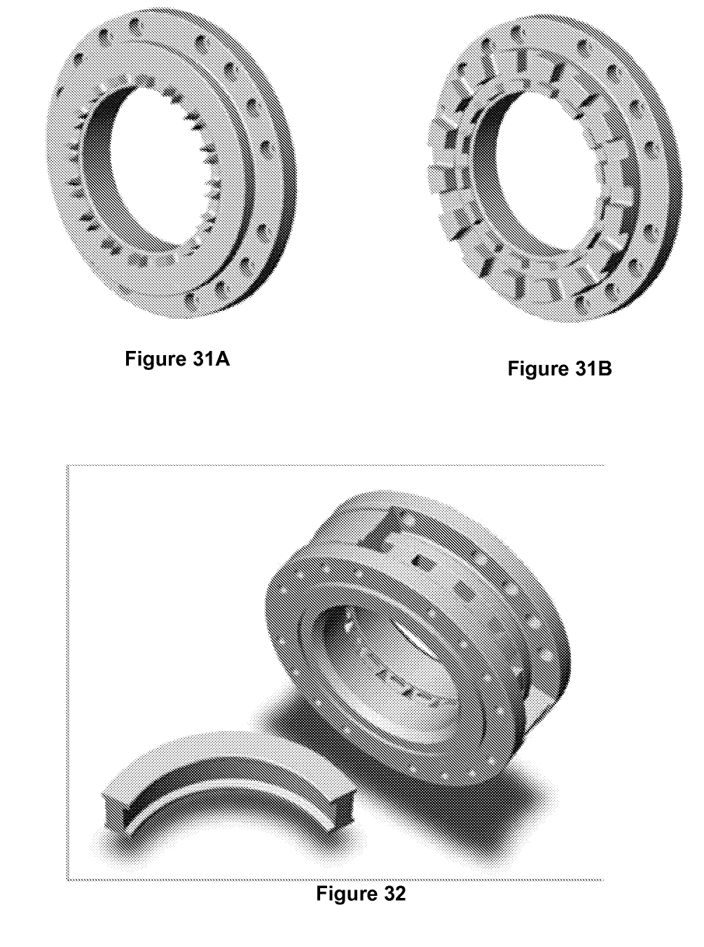

FIGS. 31A and 31B depict designed connection interface parts. FIG. 32 depicts interface parts in connection.

Although the alignment teeth are designed to have enough stiffness to endure transverse workloads, the workloads in the axial direction must be supported by utilizing the large-surface sealing contacts. The bending load transmitted from one module link is transformed into axial loads, which then flows though the closing contact of the interface to the other module. It is quite obvious, from beam theory, that keeping this internal force path at the farthest out location is beneficial for bending stiffness.

In order to achieve a good stiffness in a mechanical system, it is also important to have the internal force flow as short as possible, not to mention the good structural rigidity along the path. This principle of the shortest possible force path is illustrated in the following figure. This is a section view of the gear train part of an actuator module, connected to two link modules though the interfaces. In this design, the input and output flanges are located very close to each other, with the principal bearing in-between, to form a short and fortified major force path.

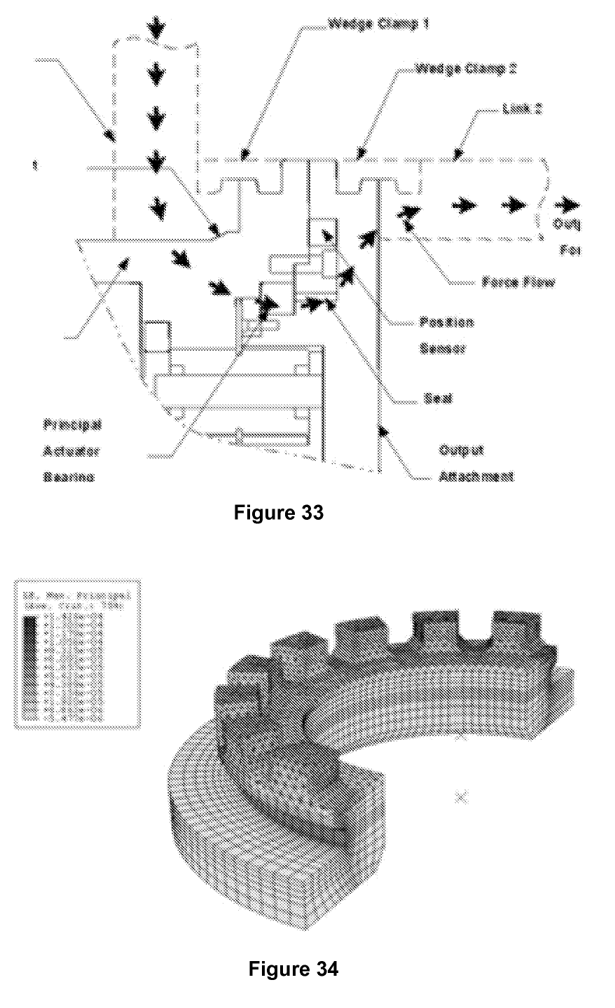

FIG. 33 depicts the force path of a standard actuator module.

In the current interface design, the largest strain occurs at the neck portion between the attachment flange and the interface area, which allows for space for the wedge extrusions of the C-clamps to be assembled. The overall structure has been optimized through maximizing the neck diameter and minimizing the neck length, while leaving enough space for allowable stress and deformations of the C-clamps. This resulted in the radial neck thickness slightly greater than the attachment flange thickness as shown in FIG. 34. The final geometries of the interface bodies are also shown in Appendix C.

The connection stiffness of the designed structure is calculated in the following for the maximum moment load of the nearest joint. Table 6.21 also lists the connection stiffness calculated using the geometry of the previous design, which is shown in a previous chapter. There has been an improvement in stiffness from the previous design by 10%. This stiffness is also comparable with the bending stiffness of a crossed roller bearing of the comparable size, which is shown below. FIG. 34 depicts a structure FEM model.

TABLE 6.21
Connection interface stiffness

| Moment | Total Connection | End-effecter | Connection Bending |
|---|---|---|---|
| Load | Deformation | Deflection | Stiffness |
| 2655 in-lb | 2.31 × 10⁻⁵ rad | 0.00083 in | 1.67 × 10⁵ ft-lb/deg |

So far, an overall process of designing an interface for one of the in-line module connections of ALPHA arm has been presented, in which application of the analytical design method developed in the previous chapters has been illustrated step by step. Although this shows one model application of the method, the underlying design procedure is general enough to be directly adopted into designing of any other compliance-based connection interfaces of modular architecture.

The design process and the achieved results are summarized as below.

1) Circular, ring-shaped interface geometry is used with the inner diameter of 4″ to allow for internal information and power flows.

2) Utilizing the clamping mechanism that employs three C-clamps and a band-spring, the obtainable total axial clamping force is 20,000 lbf.

3) The local contact geometry is obtained to have the maximum deflection and the required stiffness within the given space limits. The stress reaches 100 ksi with its 0.01″ lateral deflection under 135.6 lbf axial clamping load per local contact pair. With 32 local contact pairs, it takes 4,339 lbf to fully close the interface and up to 15,660 lbf can be used as connection preload.

4) For the pitch variations up to 0.0022″, corresponding to AGMA quality numbers 6 through 13, the designed contact teeth show only less than ±5% stress variation, whereas their stress variations reach over 300%.

5) The particular error analysis reveals that contact spring method is feasible for the designed interface, with less than 7% discrepancy from the corresponding FEM contact simulation.

6) Among different manufacturing procedures, Procedure D, with the high level of manufacturing precision, yields the 6σ radial connection accuracy of 3.9×10⁻⁵ inch and the angular accuracy of 3.3 arc sec, for 16 tooth sets on each connection body. These obtained connection accuracy values satisfy the target accuracy values initially specified in Table 6.2 and exceed the manufacturing accuracy level by more than 50%.

7) With the radial accuracy of 3.9×10⁻⁵ inch, which is much smaller than the local spring deflection of 9.0×10⁻⁴ inch, we may say that this interface has the average contact rate of 100%, which can be compared to the 8.6×10⁻⁴ inch positional accuracy and the 91.1% average contact rate of the 6-ball 6-groove interface obtained in Chapter 5.

8) The interface achieves the minimum radial stiffness of 9.16×10⁵ lbf/in and the minimum torsional stiffness of 1.28×10⁴ ft-lbf/in, purely from the local contact pairs. The separate sealing contact and its support structure allow the connection bending stiffness of 1.67×10⁵ ft-lbf/deg, and also augment the radial and torsional stiffness significantly until the friction resistance fails. All these satisfy the target stiffness values initially specified in Table 6.4.

IV. Overview

In this work, general guidelines and an analytical method is presented for designing of compliance-based connection interfaces for modular robotics. A simple structural model of the connection interface is presented using the concept of contact spring, and an approximate formulation is obtained that yields changes in relative position and orientation in the connection for given geometric manufacturing errors. The obtained linear error expression is then utilized to calculate the overall stochastic connection accuracy with manufacturing tolerance and variance values using the normal distribution model of the connection error.

The presented method can be useful in the initial phase of modular interface design for efficient generation of parameter values and the subsequent iterations to achieve the needed accuracy level, by enabling concurrent considerations on material deformations, geometry, manufacturing procedure, and tolerances. This research will be extended to the application of the method, where a design of the connection interface will be generated for a specific purpose and the achieved connection accuracy will be evaluated with respect to the performance requirement of the robot system.

The other part of the research work is to apply the mathematical formulation developed in the first part of the research to design an interface to meet the accuracy and stiffness requirements, by dealing with the design parameters and dimension tolerances simultaneously. A specific design of a robot module connection is generated, followed by FEM contact simulations for the comparative analysis on the deflections and connection errors for the introduced tolerance sets.

A. Design Strategy

For the design of high performance connection interfaces for modular robots, the following guidelines are suggested in terms of overall geometry, local contact geometry and its arrangement configuration.

Circular, ring-shaped interface geometry is proposed for the modular robot structure. It is naturally compatible with cylindrical cross-sections, which is typical of motors, actuators, and structural links. With a relatively large inner diameter, the weight can be reduced and the resulting space can be efficiently used for utilities (power generation, cooling, information and power flows, etc). A certain amount of the cylindrical exterior volume is reserved for installation of a clamping mechanism, such as the one previously designed at UT-Austin, RRG.

The alignment features for relative positioning in the connection is shaped on a flat side of the ring plate, so that two conjugate flat plates can be axially coupled. The conventional wedge-groove alignment pairs can be employed, but with well-designed local compliance for accurate positional guidance during the connection process. In order to be able to achieve the needed connection stiffness and maximize the error-averaging effect, the number of alignment features is maximized.

A sealing contact between large-area flat surfaces is provided at the end of the connection process to improve the connection stiffness. This way, the compliance in the alignment features performs accurate positioning during the clamping process and the sealing contact provides the enhanced structural support once the connection is complete. The need for bending stiffness is critical in typical robot structures. Proper geometry and machining methods must be selected for excellent surface flatness and perpendicularity with the structural link axis. Similar attempts have been made in industry to enhance both position accuracy and stiffness of interfaces by providing large face support contacts (FIG. 7.1).

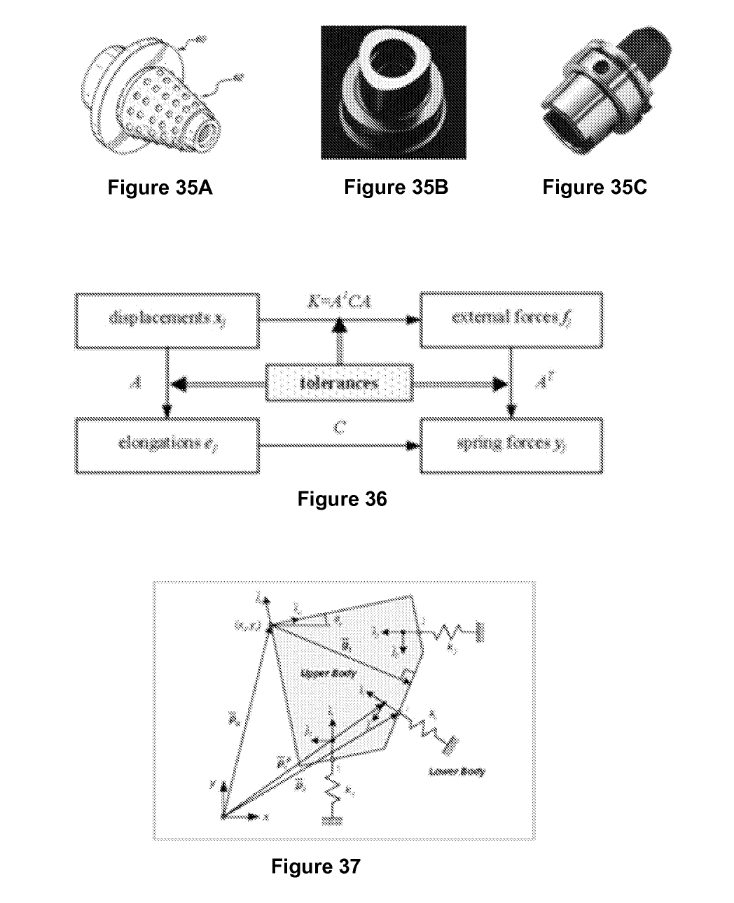

FIGS. 35A-35C depict interfaces utilizing local compliance for increased connection stiffness.

A contact between two rigid polygons can be modeled as a point-slider joint, whose pointed edge and flat surface each determines the contact position and the orientation, respectively. Use of such simple flat-to-convex contacts is thus beneficial in terms of modeling, analysis, designing, manufacturing, and consequently, the connection accuracy. The convex surface can be defined with a single curvature for simplicity to form a circular arc or a partial spherical surface.

B. Connection Formulation

In this section, the fundamental mathematical relation is outlined in terms of the four major interface design parameters: force, deflection, geometry, and tolerance. The following diagram shows the basic framework of structural mechanics with the four major components, including tolerances, and their relationships in systems of elastic springs. Arrows indicate that the relation matrices are multiplied to the components at the origin to get the destination components. FIG. 36 depicts a system model with tolerances.

In the diagram, tolerances are introduced into the flow between the external force and the global displacement to find the changes in relative position and orientation in the connection due to geometry variations. FIG. 7.3 shows a portion of the upper body, perturbed from its nominal configuration and arbitrarily positioned and oriented in space, while in connection with the lower body. The spring i represents a general contact case with an arbitrary contact orientation.

FIG. 37 depicts a dimensional interface local contact model.

The iₜₕ contact spring is associated with two vectors, \vec{p}ᵢ⁰ and \vec{p}ᵢ, originating from the global coordinate frame and pointing to the two different tip positions of the local spring, before and after its deflection. The iₜₕ local coordinate frame is located at the tip of the undeformed iₜₕ spring. The mating iₜₕ contact surface is defined with the vector of the upper body coordinate frame, u. \vec{g}ᵢ

The constitutive equation for this iₜₕ linear spring is
ⁱ\vec{F}ᵢ=ⁱ\tilde{K}ᵢⁱ\vec{q}ᵢ=ⁱ\tilde{K}ᵢⁱ\tilde{R}₀(\vec{p}ᵢ−\vec{p}ᵢ⁰) (7.1)

where the expanded local stiffness matrix and the total deflection of the spring in contact equilibrium are

$${\tilde{K}}_{i} = [ \begin{matrix}{k}_{i} & 0 & 0 \\ 0 & 0 & 0 \\ 0 & 0 & 0\end{matrix} ] \begin{matrix} \\ {{q}^{->}}_{i} \\ i\end{matrix} = [ \begin{matrix}{q}_{i} \\ 0 \\ 0\end{matrix} ]$$

using the [3×3] general rotation matrix, \tilde{R}=\tilde{R}_{z}\tilde{R}_{y}\tilde{R}ₓ.

The right subscripts of the vectors and matrices refer to the local contact geometry they belong to, and the left superscripts show the coordinate frames they are resolved into, or seen from. When a vector is seen from the global coordinate system, its left superscript is omitted for convenience.

Solving a system of vector equations with the following condition,

$$[ \begin{matrix}{{p}_{u}}^{->} \\ {{θ}_{u}}^{->}\end{matrix} ] = 0$$

the three-dimensional compatibility relation among the position, orientation of the upper body and the deflection of the iₜₕ local spring can be obtained as a linear function of the unknown parameters of the upper body, \vec{p}ᵤ and \vec{θ}ᵤ. The linearized form of this relation is, in a matrix equation,

$${}_{}^{i}{{q}^{->}}{}_{i}^{} = {\tilde{A}}_{i} \cdot [ \begin{matrix}{{p}_{u}}^{->} \\ {{θ}_{u}}^{->}\end{matrix} ] + {{b}^{->}}_{i}$$

where the two coefficient quantities are system geometry matrix and local preload vector.

Through the introduction of tolerance variables to the vectors defining the geometry of upper and lower bodies for small deviations, a geometry parameter, ξᵢ, changes to
ξ_{i,tol}=ξᵢ+δξᵢ

The new compatibility equation with differential changes is
ⁱ\vec{q}_{i,tol}=ⁱ\vec{q}ᵢ+δⁱ\vec{b}ᵢ

where the linear variation of b₁ due to the geometry variation is

$$δ {b}_{i} = \frac{\partial {b}_{i}}{\partial {ξ}_{i , 1}} δ {ξ}_{i , 1} + \frac{\partial {b}_{i}}{\partial {ξ}_{i , 2}} δ {ξ}_{i , 2} + \frac{\partial {b}_{i}}{\partial {ξ}_{i , 3}} δ {ξ}_{i , 3} … \qquad ( 7.2 )$$

In the framework of distributed coordinate systems, the force equilibrium equations using the geometry parameters including the tolerances is expressed as

$${}_{}^{0}{\tilde{R}}{}_{e}^{} {}_{}^{e}{{F}^{->}}{}_{e}^{} = - {\sum }_{i = 1}^{n} {}_{}^{0}{\tilde{R}}{}_{i , tol}^{} {}_{}^{i}{{F}^{->}}{}_{i , tol}^{}$$

$${}_{}^{0}{\tilde{R}}{}_{e}^{} {}_{}^{e}{{M}^{->}}{}_{e}^{} = - {\sum }_{i = 1}^{n} {{p}^{->}}_{i , tol} \times ( {}_{}^{0}{\tilde{R}}{}_{i , tol}^{} \cdot {}_{}^{i}{{F}^{->}}{}_{i , tol}^{} )$$

Solving the above equations using the relation of Equation (7.1) yields the position and orientation solution of the upper body,

$$[ \begin{matrix}{{p}^{->}}_{u}^{*} \\ {{θ}^{->}}_{u}^{*}\end{matrix} ] = {\tilde{K}}^{- 1} ( [ \begin{matrix}{{F}^{->}}_{e} \\ {{M}^{->}}_{e}\end{matrix} ] - {C}^{->} - {D}^{->} )$$

$$where$$

$$\tilde{K} ≃ {\sum }_{i = 1}^{n} [ \begin{matrix}{}_{}^{0}{\tilde{R}}{}_{i}^{} {}_{}^{i}{\tilde{K}}{}_{i}^{} {\tilde{A}}_{i} \\ {{p}^{->}}_{i}^{0} \times ( {}_{}^{0}{\tilde{R}}{}_{i}^{} {}_{}^{i}{\tilde{K}}{}_{i}^{} {\tilde{A}}_{i} )\end{matrix} ]$$

$${C}^{->} ≃ {\sum }_{i = 1}^{n} [ \begin{matrix} \\ {{p}^{->}}_{i}^{0}\end{matrix} {C}^{->} ≃ {\sum }_{i = 1}^{n} [ \begin{matrix}{}_{}^{0}{\tilde{R}}{}_{i}^{} {}_{}^{i}{\tilde{K}}{}_{i}^{} {{b}^{->}}_{i} \\ {{p}^{->}}_{i}^{0} \times ( {}_{}^{0}{\tilde{R}}{}_{i}^{} {}_{}^{i}{\tilde{K}}{}_{i}^{} {{b}^{->}}_{i} )\end{matrix} ]$$

are the [6×6] system stiffness matrix and initial preload vector, respectively, and

$$\vec{D} ≡ δ \vec{C} ≃ {\sum }_{i = 1}^{n} [ \begin{matrix}{}_{}^{0}{\tilde{R}}{}_{i}^{} {}_{}^{i}{\tilde{K}}{}_{i}^{} δ {\vec{b}}_{i} \\ {\vec{p}}_{i}^{0} \times ( {}_{}^{0}{\tilde{R}}{}_{i}^{} {}_{}^{i}{\tilde{K}}{}_{i}^{} δ {\vec{b}}_{i} )\end{matrix} ]$$

is the tolerance perturbation vector that reflects the changes in the local preload state. The two vectors, combined with the wrench vector, provide the desired solution of the connection state. The adjustment in the final relative position and orientation due to the geometry variation is, therefore,

$$[ \begin{matrix}δ {\vec{p}}_{u} \\ δ {\vec{θ}}_{u}\end{matrix} ] = - {\tilde{K}}^{- 1} \cdot \vec{D} ≡ \vec{E} \qquad ( 7.3 )$$

which is called the tolerance error vector.

Due to the decoupling between the force effect and the tolerance effect, the solution process may be split into two separate events connecting three different states. The first state is the known connection state and called the initial state. When the external load is fully active, the ideal connection state with nominal geometries, called the intermediate state, is reached. Finally, dimension tolerances are introduced and the final state is reached with selected changes in geometry.

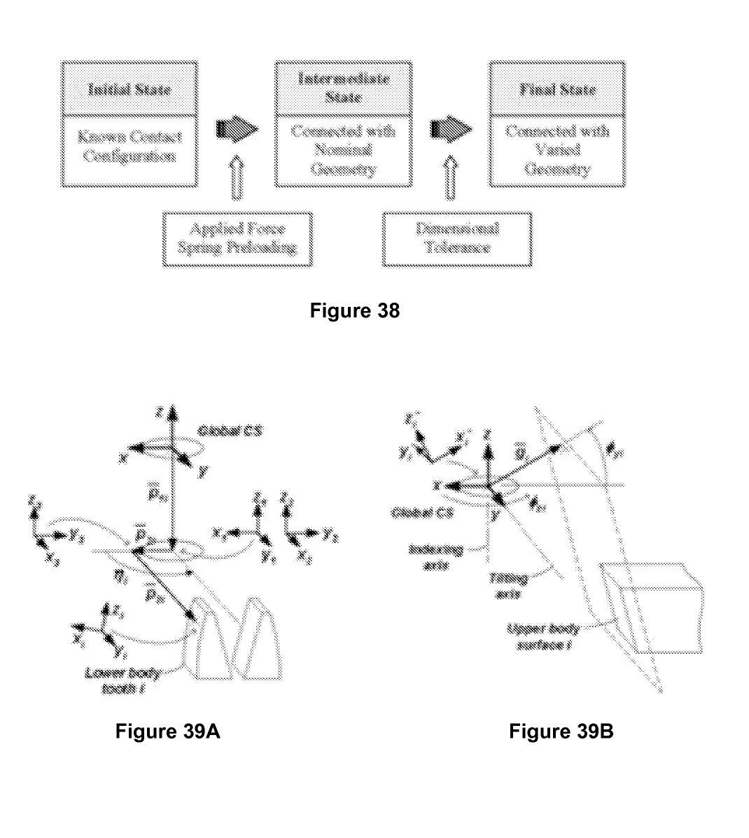

FIG. 38 depicts states of the solution process.

To comply with the linearization assumptions, the initial state must be sufficiently close to the intermediate state, which is assumed to be sufficiently close to the final state. Also, all the designated local contact pairs must have their contacts established without any gap clearance.

C. Implementation

Equation (7.2) can be expressed in the following matrix form by forming the local geometry variation vector, δX:
δ\vec{b}ᵢ=[QCᵢ]δ\vec{X}ᵢ

A new matrix, ECᵢ, for the iₜₕ contact is then defined using the above relations as

$${EC}_{i} ≡ - {[ K ]}^{- 1} [ \begin{matrix}{}_{}^{0}{\tilde{R}}{}_{i}^{} {}_{}^{i}{\tilde{K}}{}_{i}^{} \\ [ {\vec{p}}_{i}^{0} \times ] \cdot {}_{}^{0}{\tilde{R}}{}_{i}^{} {}_{}^{i}{\tilde{K}}{}_{i}^{}\end{matrix} ] [ {QC}_{i} ]$$

and the tolerance error vector of Equation (7.3) is obtained by the following matrix summation:

$$\vec{E} = {\sum }_{i = 1}^{n} [ {EC}_{i} ] [ δ {X}_{i} \qquad ( 7.4 )$$

This is the perturbation of the connection system having any number of local contacts, as a function of the local stiffness and the geometry parameters of the two connecting bodies.

A finite element contact simulation model is used to measure the level of agreement between the linear, lumped parameter solutions, obtained from the contact spring formulation, and the nonlinear solution, obtained with friction and the volumetric effect of actual geometry in misalignment. The local alignment features of the FEM model can be repositioned to emulate the introduced manufacturing imperfections. The maximum solution difference data obtained after a number of particular error analyses can be a good measure of feasibility in using the contact spring model as an accuracy analysis tool for the given design.

Once the structural model is generated, it can be utilized for stochastic accuracy analysis by assuming normal distribution of the connection errors from random coupling, based on the central limit theorem [4]. For this, a matrix that has the absolute values of the ECᵢ elements and another matrix that has the squared quantities of the ECᵢ elements are defined, as below.

$${ECA}_{i} ≡ [ \begin{matrix}\vert {( {EC}_{i} )}_{11} \vert & ⋯ & \vert {( {EC}_{i} )}_{16} \vert \\ ⋮ & ⋰ & \\ \vert {( {EC}_{i} )}_{61} \vert & ⋯ & \vert {( {EC}_{i} )}_{66} \vert\end{matrix} ]$$

$${ECS}_{i} ≡ [ \begin{matrix}{( {EC}_{i} )}_{11}^{2} \\ ⋮ \\ {( {EC}_{i} )}_{61}^{2}\end{matrix} \text{?} \\ {ECS}_{i} ≡ [ \begin{matrix}{( {EC}_{i} )}_{11}^{2} & ⋯ & {( {EC}_{i} )}_{16}^{2} \\ ⋮ & ⋰ & \\ {( {EC}_{i} )}_{61}^{2} & ⋯ & {( {EC}_{i} )}_{66}^{2}\end{matrix} ] \\ \text{?} \text{indicates text missing or illegible when filed}$$

Also, the local tolerance vector, TXᵢ, and the local variance vector, VXᵢ, are formed in the same manner the local geometry variation vector, δXᵢ, was formed. The local variance vector contains the unit distribution variance values obtained from actual machining data.

The maximum possible ranges of the tolerance errors and the variance of the relative position are obtained from the vector summations;

$$RE = {\sum }_{i = 1}^{n} [ {ECA}_{i} ] [ {TX}_{i} ] \\ VE = {\sum }_{i = 1}^{n} {[ {ECS}_{i} ] [ diag ( {TX}_{i} ) ]}^{2} [ {VX}_{i} ] \qquad ( 7.5 )$$

Here, diag means a diagonal matrix whose non-zero diagonal elements come from the argument vector. Finally, the 6σ connection accuracy is obtained as
Accᵢ=CL\sqrt{VEᵢ} (7.6)

with CL=6.0 corresponding to the confidence level of 99.73%.

Each vector that defines the local geometry in the basic formulation may be replaced with a vector chain as long as the sum direction and magnitude are equal to the original vector. This vector chain formation adds versatility to the formulation for adapting to the actual geometry and the manufacturing methods.

In FIG. 7.5, the lower body teeth positions are defined using a vector chain, reflecting the circular arrangement of the teeth and the resulting need for indexing operations in manufacturing. The chain consists of three vectors, passing though three intermediate coordinate frames to reach the undeformed position of the virtual contact spring. Each of three component vectors may have variations to represent the lower body teeth positioning errors, such as circumferential position error, axial position error, and radial position error.

The flat contact surface of the upper body in FIGS. 39A and 39B is defined by vector gᵢ originating from the coordinate from i* along its x-direction, which is rotated from the upper body coordinate frame. This chain allows rotational variation of the contact surface about the upper body reference point.

FIGS. 39A and 39B depicts lower body (left) and upper body (right) coordinate system distribution example.

Depending on the manufacturing procedure the coupling parts go through, some geometric parameters become linked together. For example, two different surfaces can be constrained together in their position variations, sharing a common error. In other cases, a single surface may be cut with more than one error source contributed by different positioning devices. Thus, the geometric parameters of a machined part can be linked by either of the following relations:
δX=A₁δx₁=A₂δx₂= - - - =Aₙδxₙ
δX=δx₁+δx₂+δx₃+ - - - +δxₙ

In order for the introduced tolerance and variance values to have correct influences on the connection accuracy, different parameters of simultaneous variations should be merged into a single variation parameter, whereas a single parameter containing multiple independent variation sources must be decomposed into several child parameters. This can be handled by manipulating the corresponding columns of the coefficient matrix of Equation (7.4).

Once the parameter linking process is complete, the fully modified coefficient sub-matrices, ECmᵢ, can be arranged to form the following matrix:
\tilde{S}≡[ECm₁|ECm₂|ECm₃| - - - |ECmₖ]

This is the sensitivity matrix of the connection system, which relates all the independent variation parameters to the six independent connection errors. Each element of the sensitivity matrix, Sᵢⱼ is the partial derivative,

$${S}_{ij} = \frac{\partial {E}_{i}}{\partial {x}_{j}}$$

of the iₜₕ error with respect to the jₜₕ geometry parameter, and it is the weight factor that indicates the amount of contribution to the total error from the corresponding dimension parameter.

D. Design Application

So far, an overall process of designing an interface for one of the in-line module connections of ALPHA arm has been presented, in which application of the analytical design method developed in the previous chapters has been illustrated step by step. Although this shows one application of the method, the underlying design procedure is general enough to be directly adopted into designing of any other compliance-based connection interfaces of the modular architecture. The design process and the achieved results are summarized below.

A circular, ring-shaped interface geometry is used with the inner diameter of 4″ to allow for internal information and power flows. The previous interface design of the ALPHA manipulator incorporates a Voss clamp arrangement, where two flanges of the coupling modules are mated together using inner-wedged clamping members and then a steel band is situated around the outer circumference formed by the clamping members. Due to the superiority in many practical aspects, this clamping mechanism is used for the new design, with further optimizations in the geometry. Utilizing three C-clamps in this clamping mechanism, the obtainable total axial clamping force is 20,000 lbf. Alloy steel 4340 is used for the interface material to improve the connection stiffness.

Having established the available total axial clamping force, an initial design of the local contact geometry is generated so that the clamping force fully closes all the local contact pairs. In this work, the local contact geometry is designed to utilize structural bending compliance. Designing with structural compliance has the following strong points: 1) large deflections can be achieved with limited applied closing loads, 2) the overall arrangement of local springs can be done in an unconstrained manner, and 3) the alignment feature beam geometry can be manufactured relatively easily compared to three-dimensional surface curvatures.

The six major parameters associated with local contact geometry design are;

1. Overall tooth profile

2. Angle of contact

3. Tooth height

4. Tooth depth

5. Tooth stiffness

6. Number of tooth pairs

The local contact geometry is obtained to have the maximum deflection and the required stiffness within the given space limits. With 32 local contact pairs, it takes 4,339 lbf to fully close the interface and up to 15,660 lbf can be set aside as the connection preload.

For pitch variations within a reasonable range, the designed contact teeth showed a relatively small amount of stress variation, which justifies the constant stiffness modeling of the interface connection. Also, the particular error analysis reveals that the contact spring method is feasible for the designed interface, with acceptable differences between the contact spring solution and the corresponding FEM contact simulation.

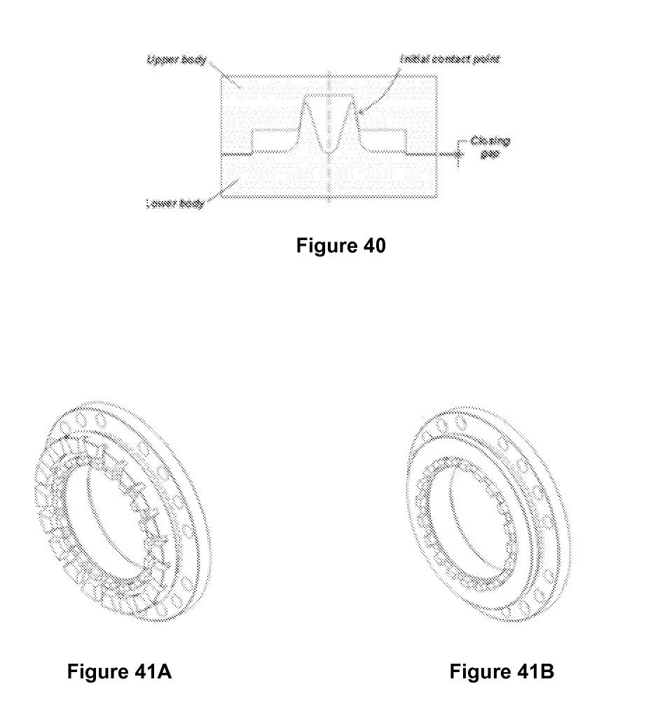

FIG. 40 depicts a designed local contact geometry.

The analysis results revealed that different manufacturing procedures result in different accuracy levels for the same applied machining tolerances. Both the use of more contact teeth and the reduced number of tool movements during manufacturing enhanced the connection accuracy. Although the relation between the number of local contacts and the connection accuracy varies depending on the parameter linking patterns and the introduced tolerance values, the dominant rule extracted from Equations (7.5) and (7.6) is that, in general, increasing the number of contacts of an interface by a factor of k tends to multiply the connection accuracy by \sqrt{k}.

With high level of manufacturing precision and 16 tooth sets on each connection body, the 6σ radial connection accuracy of 3.8×10⁻⁵ inch and the angular accuracy of 3.3 arc seconds were achieved, and these values are listed in Table 7.1, together with the ball-groove interface results discussed in Chapter 5. Although direct comparison is difficult since they represent completely different interfaces designed and manufactured differently, lessons can be earned from this comparison.

First, it is easier to achieve higher contact ratio with structural compliance rather than contact compliance, which leads to both higher accuracy and better accuracy prediction. The ball-groove couplings are quite limited in the amount of available local deflections. Secondly, interfaces should be designed in such a way that their manufacturing is simple and less associated with errors. The ball-groove coupling is more likely to have larger errors from separate manufacturing of the half-balls and fixing them at the prepared seat locations.

TABLE 7.1
Connection accuracy comparison

| | | | Average |
|---|---|---|---|
| | Radial | Angular | Contact |
| | Accuracy | Accuracy | Ratio |
| 6-ball 6-groove interface | 896 × 10⁻⁵ in | 72 arc sec | 91.1% |
| Designed interface with 16 tooth | 3.9 × 10⁻⁵ in | 3.3 arc sec | 100% |
| sets | | | |

The interface achieves the minimum radial stiffness of 9.2×10⁵ lbf/in and the minimum torsional stiffness of 1.3×10⁴ ft-lbf/in, purely from the local contact pairs. The separate sealing contact and its support structure allow the connection bending stiffness of 1.7×10⁵ ft-lbf/deg. All these satisfy the target stiffness values initially specified in Table 7.2.

TABLE 7.2
Connection stiffness comparison

| | Translational | Bending | |
|---|---|---|---|
| | stiffness | stiffness | Torsional stiffness |
| Interface | 152 lbf | 519 ft-lbf | 177 ft-lbf |
| workload | | | |
| Allowable | 0.002 in | 11.5 arcsec | 49.9 arcsec |
| deformation | | | |
| Target stiffness | 7.60 × 10⁴ lbf/in | 1.62 × 10⁵ | 1.28 × 10⁴ ft-lbf/deg |
| | | ft-lbf/deg | |
| Achieved | 91.6 × 10⁴ lbf/in | 1.67 × 10⁵ | 1.28 × 10⁴ ft-lbf/deg |
| stiffness | (Minimum) | ft-lbf/deg | (Minimum) |

### V. SUMMARY

The major contribution of this work to the modular robotics is the development of a design method for module connection interfaces that allows designers to evaluate the effect of design tolerances over the connection state. An application of this method has been demonstrated through the designing of a specific interface that can replace one of the module connection interfaces of the ALPHA manipulator, previously designed and partially built by the Robotics Research Group of the University of Texas at Austin. Through this application, the usefulness, the efficiency and the reliability of the analytical design method have been carefully studied and verified.

Although this particular design is a good example of application of the presented design method, only two-dimensional error analysis was necessary, since three degrees of relative freedom are restrained by the large surface sealing contact for enhanced connection stiffness. This method is equally good for three-dimensional error analysis in six degrees of freedom. The local stiffness can be nonlinear, given the condition that the linearization assumption can be valid in the range of local preload variations. Also, unlike the designed interface, the approach presented here permits the local contact springs to be arranged in any manner, regular or irregular, with either uniform stiffness or varying stiffness across different springs. This is an important point in terms of the designer's freedom in configuration management.

The greatest potential of this method is that practically an unlimited number of local springs can be used in the analysis to stochastically predict the connection accuracy, without significant computational difficulties. In fact, the more local error sources exist, the better the analysis result. Another strength of the method is its versatility to adapt to any manufacturing methods selected for the interface being designed. Any local geometry parameters can be merged together to represent a single error source, and any parameters can be decomposed into a desired number of independent parameters of the same sensitivity, for known independent error sources.

Having established the fundamental design method, many interface designs of different accuracy and stiffness levels can be produced utilizing the method. One possible variation of the design presented in this work is shown in FIG. 7.7, whose contact teeth are cut following the method of generating Curvic couplings in order to utilize the contact compliance of the curved surfaces. Yet, this interface gets the strong added support from the outer flat sealing contacts for increased bending stiffness. This design is suitable for applications where a large clamping load is available to maintain a good contact ratio. We can also consider introducing tooth-end slots to this design for enhanced local compliance from both contact deflection and structural deflection and still make use of the established method of generating Curvic couplings, if necessary.

FIGS. 41A and 41B depict an interface concept utilizing contact compliance.

Just as different classes of modular actuators can be defined based on the required load capacity, ruggedness, etc, a hierarchy of connection interfaces can be generated based on the levels of connection accuracy and stiffness required in various applications. As part of the complete architecture for modular systems, this hierarchy will guide the selection of design specifications for module connection interfaces for different modular systems such as educational robots, inspection robots, light assembly robots, and force-control robots.

The establishment of the hierarchy of modular connection interfaces then can be followed by the development of an efficient, possibly automated to some degree, overall design procedure that incorporates the developed analytical design method to synthesize optimal interface design solutions according to the levels of required accuracy, stiffness, and ruggedness. This requires proper design criteria, design functions, and nonlinear search techniques, which together form a large closed loop by connecting the start and the end of the design work presented in Chapter 6.

Later, the above design method or design procedure can be employed in development of interfaces for actual modular systems. In that case, the applied design tolerances can be based on the real manufacturing data of the particular machines to be used. This will produce more practical connection accuracy values, which can be compared with the measured connection errors from experiments using different sets of manufactured interface bodies. Both the connection repeatability and the connection accuracy can be studied through the experiments of repeated mating of permanent pairs and the experiments of interchanging randomly selected different interface bodies, respectively.

We claim:

1. A robotic system for providing precision interfaces between a rotary actuator and at least one robotic structure, comprising:
a robotic structure responsive to control by a rotary actuator;
connection means for connecting said robotic structure to a rotary actuator, said connection means further comprising means for relating at least one significant interface design parameter to a relative position and orientation of said connection means; and
a rotary actuator for controlling the response of said robotic structure, said rotary actuator comprising:
an actuator shell;
an eccentric cage, disposed within the actuator shell;
a prime mover having a first prime mover portion rigidly fixed to the actuator shell and a second prime mover portion, rotatable with respect to the first prime mover portion, rigidly fixed to the eccentric cage, and capable of exerting a torque on the first prime mover portion;
a cross-roller bearing having a first bearing portion rigidly fixed to the actuator shell and a second bearing portion, free in rotation with respect to the first bearing portion;
an output attachment plate rigidly fixed to. the second bearing portion;
a shell gear rigidly fixed to the actuator shell;
an output gear rigidly fixed to the output attachment plate;
an eccentric, disposed about the eccentric cage, having a first gear portion meshed to the shell gear and a second gear portion, adjacent to the first gear portion, meshed to the output gear;
a first structural link rigidly attached to the actuator shell using by quick-change attachment structure; and
a second structural link rigidly attached to the output attachment plate by quick-change attachment structure.
